(19) United States
(12) Patent Application Publication
(10) Pub. No.: US 2024/0004977 A1
(43) Pub. Date: Jan. 4, 2024

(54) SEQUENCE-BASED AUTHENTICATION USING RHYTHM AND/OR POSES

(71) Applicant: Microsoft Technology Licensing, LLC, Redmond, WA (US)

(72) Inventors: Rachel Anne BROWN TELLER, New York, NY (US); Steven J. BALL, Redmond, WA (US); Michael Vincent MCLAUGHLIN, Seattle, WA (US)

(21) Appl. No.: 17/855,761

(22) Filed: Jun. 30, 2022

(51) Int. Cl. G06F 21/32

(52) U.S. Cl. CPC G06F 21/32

(57) ABSTRACT

Techniques are described herein that are capable of providing sequence-based authentication using rhythm and/or poses. A user-defined secret of a user is received. The user-defined secret indicates a user-defined sequence, which includes a sequence of shapes, a rhythmic sequence of sounds, and/or a rhythmic sequence of visual gestures. A first request for the user to be granted access to a resource is received. A second request, requesting that the user repeat the user-defined sequence, is caused to be presented via a user interface of a computing system. A second sequence, which is included in a response to the second request, is compared to the user-defined sequence. Access to the resource is provided to the user based at least in part on the second sequence corresponding to the user-defined sequence.

### BACKGROUND

Authentication of a user establishes truth of an assertion that an entity is the user. The authentication can be established based on something the user knows (e.g., only the user knows), something the user has (e.g., only the user has), and/or something the user is (e.g., only the user is). For authentication that is based on something the user knows, the assertion often includes a password or personal identification number (PIN) that is associated with the entity. Truth of the assertion may be established by confirming that the password or PIN in the assertion corresponds to a predefined password or PIN that is associated with the user. However, some users (e.g., school students who are young or who have learning impairments) may be cognitively unable to remember a predefined password or PIN, or the desired level of security may not necessitate use of a predefined password or PIN. One proposed solution is to require a user to select the user's favorite color from a palette of colors in order to authenticate the user. Although the user's favorite color may be easier for the user to remember than a password or PIN, it may be desirable to use an authentication technique that provides greater security.

### SUMMARY

Various approaches are described herein for, among other things, providing sequence-based authentication using rhythm and/or poses. Sequence-based authentication is authentication that relies on a sequence to establish truth of an assertion that an entity is a user. For example, the assertion may include a sequence that is associated with the entity. The sequence may be compared to a reference sequence that is associated with the user to determine whether the entity is the user. The sequence in the assertion corresponding to the reference sequence weighs in favor of a determination that the entity is the user. For instance, the sequence in the assertion corresponding to the reference sequence may definitively confirm that the entity is the user if no other factors are taken into consideration. The sequence in the assertion may be deemed to correspond to the reference sequence based on (e.g., based at least in part on) a similarity between the sequence in the assertion and the reference sequence satisfying a similarity criterion. For instance, the similarity criterion may require that a difference between the sequence in the assertion and the reference sequence is less than or equal to a threshold difference and/or that a probability that the sequence in the assertion is different from the reference sequence is less than or equal to a threshold probability. The sequence in the assertion not corresponding to the reference sequence weighs against a determination that the entity is the user. For instance, the sequence in the assertion not corresponding to the reference sequence may definitively confirm that the entity is not the user if no other factors are taken into consideration. The sequence in the assertion may be deemed not to correspond to the reference sequence based on (e.g., based at least in part on) the similarity between the sequence in the assertion and the reference sequence not satisfying the similarity criterion.

In a first example approach that uses rhythm, a first sequence request, which requests that a user generate a rhythmic sequence of sounds, is caused to be presented via a user interface of a computing system. A response to the first sequence request is received via a microphone. The response to the first sequence request includes a first user-generated rhythmic sequence of sounds. A resource request for the user to be granted access to a resource is received. Based at least in part on receipt of the resource request, a second sequence request, which requests that the user repeat the first user-generated rhythmic sequence of sounds, is caused to be presented via the user interface. A response to the second sequence request is received via the microphone. The response to the second sequence request includes a second user-generated rhythmic sequence of sounds. The second user-generated rhythmic sequence of sounds is compared to the first user-generated rhythmic sequence of sounds. Access to the resource is provided to the user based at least in part on a similarity between the second user-generated rhythmic sequence of sounds and the first user-generated rhythmic sequence of sounds satisfying a similarity criterion.

In a second example approach that uses rhythm, a first sequence request, which requests that a user provide a rhythmic sequence of visual gestures, is caused to be presented via a user interface of a computing system. A response to the first sequence request is received via a camera. The response to the first sequence request includes a first rhythmic sequence of visual gestures. A resource request for the user to be granted access to a resource is received. Based at least in part on receipt of the resource request, a second sequence request, which requests that the user repeat the first rhythmic sequence of visual gestures, is caused to be presented via the user interface. A response to the second sequence request is received via the camera. The response to the second sequence request includes a second rhythmic sequence of visual gestures. The second rhythmic sequence of visual gestures is compared to the first rhythmic sequence of visual gestures. Access to the resource is provided to the user based at least in part on a similarity between the second rhythmic sequence of visual gestures and the first rhythmic sequence of visual gestures satisfying a similarity criterion.

In an example approach that uses poses, a user-defined secret of a user is received. The user-defined secret indicates a sequence of shapes. A first request for the user to be granted access to a resource is received. The sequence of shapes is caused to be presented via a user interface of a computing system that is associated with the user. A second request, which requests that the user perform a sequence of poses in which a body (e.g., an entirety of the body or a portion of the body) of the user resembles the sequence of respective shapes, is caused to be presented via the user interface. A performance of the sequence of poses is compared to the sequence of respective shapes. Access to the resource is provided to the user based at least in part on the performance of the sequence of poses corresponding to the sequence of respective shapes.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Moreover, it is noted that the invention is not limited to the specific embodiments described in the Detailed Description and/or other sections of this document. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form part of the specification, illustrate embodiments of the present invention and, together with the description, further serve to explain the principles involved and to enable a person skilled in the relevant art(s) to make and use the disclosed technologies.

FIG. 1 is a block diagram of an example sequence-based authentication system in accordance with an embodiment.

FIG. 2 depicts a flowchart of an example method for performing sequence-based authentication using poses in accordance with an embodiment.

FIGS. 3-4 depict flowcharts of example methods for performing sequence-based authentication using rhythm in accordance with embodiments.

FIG. 5 is a block diagram of an example computing system in accordance with an embodiment.

FIG. 6 is a system diagram of an example mobile device in accordance with an embodiment.

FIG. 7 depicts an example computer in which embodiments may be implemented.

The features and advantages of the disclosed technologies will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

### I. Introduction

The following detailed description refers to the accompanying drawings that illustrate exemplary embodiments of the present invention. However, the scope of the present invention is not limited to these embodiments, but is instead defined by the appended claims. Thus, embodiments beyond those shown in the accompanying drawings, such as modified versions of the illustrated embodiments, may nevertheless be encompassed by the present invention.

References in the specification to “one embodiment,” “an embodiment,” “an example embodiment,” or the like, indicate that the embodiment described may include a particular feature, structure, or characteristic, but every embodiment may not necessarily include the particular feature, structure, or characteristic. Moreover, such phrases are not necessarily referring to the same embodiment. Furthermore, when a particular feature, structure, or characteristic is described in connection with an embodiment, it is submitted that it is within the knowledge of one skilled in the relevant art(s) to implement such feature, structure, or characteristic in connection with other embodiments whether or not explicitly described.

Descriptors such as “first”, “second”, “third”, etc. are used to reference some elements discussed herein. Such descriptors are used to facilitate the discussion of the example embodiments and do not indicate a required order of the referenced elements, unless an affirmative statement is made herein that such an order is required.

### II. Example Embodiments

Example embodiments described herein are capable of providing sequence-based authentication using rhythm and/or poses. Sequence-based authentication is authentication that relies on a sequence to establish truth of an assertion that an entity is a user. For example, the assertion may include a sequence that is associated with the entity. The sequence may be compared to a reference sequence that is associated with the user to determine whether the entity is the user. The sequence in the assertion corresponding to the reference sequence weighs in favor of a determination that the entity is the user. For instance, the sequence in the assertion corresponding to the reference sequence may definitively confirm that the entity is the user if no other factors are taken into consideration. The sequence in the assertion may be deemed to correspond to the reference sequence based on (e.g., based at least in part on) a similarity between the sequence in the assertion and the reference sequence satisfying a similarity criterion. For instance, the similarity criterion may require that a difference between the sequence in the assertion and the reference sequence is less than or equal to a threshold difference and/or that a probability that the sequence in the assertion is different from the reference sequence is less than or equal to a threshold probability. The sequence in the assertion not corresponding to the reference sequence weighs against a determination that the entity is the user. For instance, the sequence in the assertion not corresponding to the reference sequence may definitively confirm that the entity is not the user if no other factors are taken into consideration. The sequence in the assertion may be deemed not to correspond to the reference sequence based on (e.g., based at least in part on) the similarity between the sequence in the assertion and the reference sequence not satisfying the similarity criterion.

Example techniques described herein have a variety of benefits as compared to conventional techniques for authenticating a user. For instance, the example techniques may enable a user who is cognitively unable to remember a password or PIN to gain access to a resource by authenticating the user using rhythm and/or poses. By enabling the user to gain access to the resource, the example techniques may increase efficiency and/or a user experience of the user. By using rhythm and/or poses to authenticate the user, security of the resource, a computing system that hosts the resource, and/or the user may be increased. For instance, the example techniques may reduce a likelihood that a malicious entity is able to guess a secret that is used to authenticate the user.

The example techniques may reduce an amount of time and/or resources (e.g., processor cycles, memory, network bandwidth) that is consumed to authenticate a user. For instance, by using rhythm and/or poses to authenticate the user, the time and/or resources that would have been consumed to authenticate the user in the event that the user forgets the user's password or PIN can be avoided, which may further increase the efficiency and/or user experience of the user. By reducing the amount of time and/or resources that is consumed by a computing system to authenticate a user, the efficiency of the computing system may be increased.

The example techniques may enable a user to authenticate by providing a non-typing input (e.g., a non-alphanumeric sequence). The example techniques may enable authentication of a user in lower-security environments in which a password or PIN is not necessary while maintaining a desired level of security. For instance, if the environment is a grade school classroom, the user may be a student who authenticates in order to access shared class lessons. Authenticating the user in accordance with any of the techniques described herein may provide the user a sufficient level of security against identity theft without undue complexity. The fear of other users seeing a secret sequence of poses, overhearing a secret rhythmic sequence of sounds, or seeing a secret rhythmic sequence of visual gestures may be acceptable when the authentication is used primarily to differentiate between users (e.g., students in a classroom) rather than to harden security between the users. The example techniques may provide a fun way for the user to authenticate, further increasing the user experience of the user.

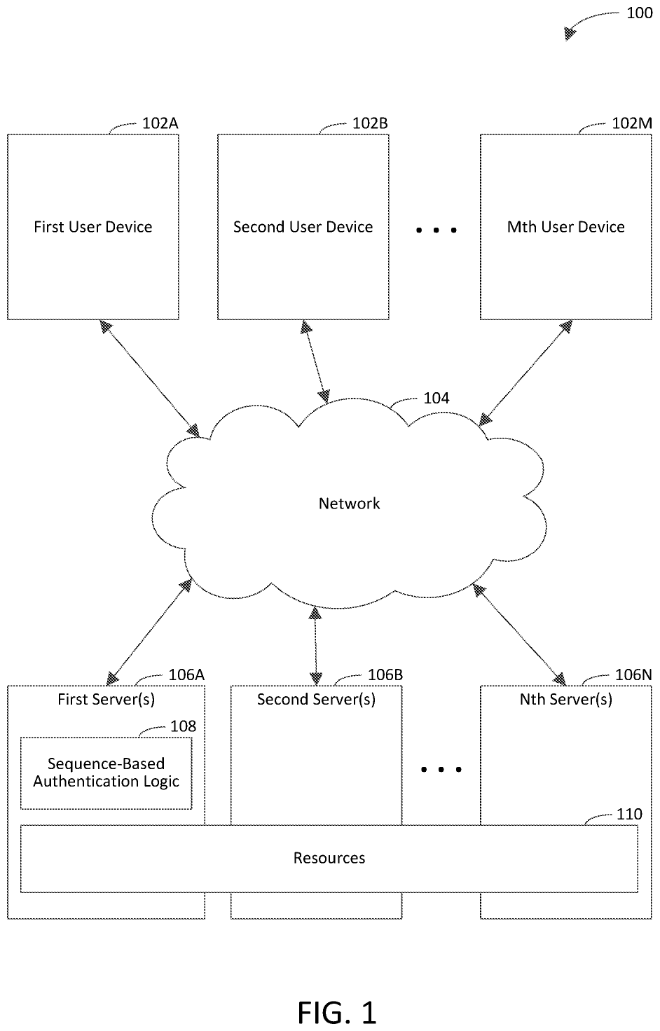

FIG. 1 is a block diagram of an example sequence-based authentication system 100 in accordance with an embodiment. Generally speaking, the sequence-based authentication system 100 operates to provide information to users in response to requests (e.g., hypertext transfer protocol (HTTP) requests) that are received from the users. The information may include documents (Web pages, images, audio files, video files, etc.), output of executables, and/or any other suitable type of information. In accordance with example embodiments described herein, the sequence-based authentication system 100 performs sequence-based authentication using rhythm and/or poses. Detail regarding techniques for performing sequence-based authentication using rhythm and/or poses is provided in the following discussion.

As shown in FIG. 1, the sequence-based authentication system 100 includes a plurality of user devices 102A-102M, a network 104, and a plurality of servers 106A-106N. Communication among the user devices 102A-102M and the servers 106A-106N is carried out over the network 104 using well-known network communication protocols. The network 104 may be a wide-area network (e.g., the Internet), a local area network (LAN), another type of network, or a combination thereof.

The user devices 102A-102M are computing systems that are capable of communicating with servers 106A-106N. A computing system is a system that includes a processing system comprising at least one processor that is capable of manipulating data in accordance with a set of instructions. For instance, a computing system may be a computer, a personal digital assistant, etc. The user devices 102A-102M are configured to provide requests to the servers 106A-106N for requesting information stored on (or otherwise accessible via) the servers 106A-106N. For instance, a user may initiate a request for executing a computer program (e.g., an application) using a client (e.g., a Web browser, Web crawler, or other type of client) deployed on a user device 102 that is owned by or otherwise accessible to the user. In accordance with some example embodiments, the user devices 102A-102M are capable of accessing domains (e.g., Web sites) hosted by the servers 104A-104N, so that the user devices 102A-102M may access information that is available via the domains. Such domain may include Web pages, which may be provided as hypertext markup language (HTML) documents and objects (e.g., files) that are linked therein, for example.

Each of the user devices 102A-102M may include any client-enabled system or device, including but not limited to a desktop computer, a laptop computer, a tablet computer, a wearable computer such as a smart watch or a head-mounted computer, a personal digital assistant, a cellular telephone, an Internet of things (IoT) device, or the like. It will be recognized that any one or more of the user devices 102A-102M may communicate with any one or more of the servers 106A-106N.

The servers 106A-106N are computing systems that are capable of communicating with the user devices 102A-102M. The servers 106A-106N are configured to execute computer programs that provide information to users in response to receiving requests from the users. For example, the information may include documents (Web pages, images, audio files, video files, etc.), output of executables, or any other suitable type of information. In accordance with some example embodiments, the servers 106A-106N are configured to host respective Web sites, so that the Web sites are accessible to users of the sequence-based authentication system 100. The servers 106A-106N are shown to include resources 110 for non-limiting, illustrative purposes. Examples of a resource include but are not limited to storage (e.g., memory), a peripheral device (e.g., a printer), another computing system, and information (e.g., a computer program or data). For instance, the data may be configured as a file (e.g., a word processing file, a spreadsheet file, or an executable file). The resources 110 may be distributed among the servers 106A-106N, though it will be recognized that any one or more of the resources 110 may be included in a single server. Moreover, any one or more of the resources 110 (or any portion thereof) may be distributed among the user devices 102A-102M or included in a single user device.

The first server(s) 106A are shown to include sequence-based authentication logic 108 for illustrative purposes. The sequence-based authentication logic 108 is configured to perform sequence-based authentication using rhythm and/or poses. In a first example implementation that performs sequence-based authentication using rhythm, the sequence-based authentication logic 108 causes a first sequence request to be presented via a user interface of a computing system. The first sequence request requests that a user generate a rhythmic sequence of sounds. The sequence-based authentication logic 108 receives a response to the first sequence request via a microphone. The response to the first sequence request includes a first user-generated rhythmic sequence of sounds. The sequence-based authentication logic 108 receives a resource request for the user to be granted access to a resource. Based at least in part on receipt of the resource request, the sequence-based authentication logic 108 causes a second sequence request to be presented via the user interface. The second sequence request requests that the user repeat the first user-generated rhythmic sequence of sounds. The sequence-based authentication logic 108 receives a response to the second sequence request via the microphone. The response to the second sequence request includes a second user-generated rhythmic sequence of sounds. The sequence-based authentication logic 108 compares the second user-generated rhythmic sequence of sounds to the first user-generated rhythmic sequence of sounds. The sequence-based authentication logic 108 provides access to the resource to the user based at least in part on a similarity between the second user-generated rhythmic sequence of sounds and the first user-generated rhythmic sequence of sounds satisfying a similarity criterion.

In a second example implementation that performs sequence-based authentication using rhythm, the sequence-based authentication logic 108 causes a first sequence request to be presented via a user interface of a computing system. The first sequence request requests that a user provide a rhythmic sequence of visual gestures. The sequence-based authentication logic 108 receives a response to the first sequence request via a camera. The response to the first sequence request includes a first rhythmic sequence of visual gestures. The sequence-based authentication logic 108 receives a resource request for the user to be granted access to a resource. Based at least in part on receipt of the resource request, the sequence-based authentication logic 108 causes a second sequence request to be presented via the user interface. The second sequence request requests that the user repeat the first rhythmic sequence of visual gestures. The sequence-based authentication logic 108 receives a response to the second sequence request via the camera. The response to the second sequence request includes a second rhythmic sequence of visual gestures. The sequence-based authentication logic 108 compares the second rhythmic sequence of visual gestures to the first rhythmic sequence of visual gestures. The sequence-based authentication logic 108 provides access to the resource to the user based at least in part on a similarity between the second rhythmic sequence of visual gestures and the first rhythmic sequence of visual gestures satisfying a similarity criterion.

In an example implementation that performs sequence-based authentication using poses, the sequence-based authentication logic 108 receives a user-defined secret of a user. The user-defined secret indicates a sequence of shapes. The sequence-based authentication logic 108 receives a first request for the user to be granted access to a resource. The sequence-based authentication logic 108 causes the sequence of shapes to be presented via a user interface of a computing system that is associated with the user. The sequence-based authentication logic 108 causes a second request to be presented via the user interface. The second request requests that the user perform a sequence of poses in which a body of the user resembles the sequence of respective shapes. Examples of a pose include but are not limited to a hand pose (e.g., a single-hand pose or a double-hand pose), an arm pose, and a full-body pose. A single-hand pose is a hand gesture in which one of a user's hands is configured to form a shape. A double-hand pose is a hand gesture in which both of a user's hands are configured to collaboratively form a shape. An arm pose is a gesture in which one of a user's arms is configured to form a shape or both of the user's arms are configured to collaboratively form the shape. A full-body pose is a gesture in which an entirety of a user's body is configured to form a shape. The sequence-based authentication logic 108 compares a performance of the sequence of poses to the sequence of respective shapes. The sequence-based authentication logic 108 provides access to the resource to the user based at least in part on the performance of the sequence of poses corresponding to the sequence of respective shapes.

In these example implementations, each sequence may be defined by a start time and an end time. The start time may be defined by initiation of a temporally first pose, sound, or visual gesture in the sequence. The end time may be defined by completion of a temporally last pose, sound, or visual gesture in the sequence.

The sequence-based authentication logic 108 may use machine learning to perform at least some of its operations. For instance, the sequence-based authentication logic 108 may use the machine learning to analyze (e.g., develop and/or refine an understanding of) secret sequences and repeated sequences, relationships between the secret sequences and the repeated sequences, and confidences in those relationships. For example, the sequence-based authentication logic 108 may use the machine learning to compare attributes of the secret sequences and attributes of the repeated sequences to determine whether the secret sequences correspond to the repeated sequences (e.g., for purposes of authenticating the user).

In some example embodiments, the sequence-based authentication logic 108 uses a neural network to perform the machine learning to determine relationships between attributes of the secret sequences and attributes of the repeated sequences and confidences in the relationships. The sequence-based authentication logic 108 use those determinations to determine whether the secret sequences correspond to the repeated sequences. For instance, the attributes of the secret sequences and the attributes of the repeated sequences may be analyzed to determine similarities and differences between the attributes of the secret sequences and the attributes of the repeated sequences, and a determination may be made whether the secret sequences correspond to the repeated sequences based on the similarities and differences between the attributes of the secret sequences and the attributes of the repeated sequences.

Examples of a neural network include but are not limited to a feed forward neural network and a long short-term memory (LSTM) neural network. A feed forward neural network is an artificial neural network for which connections between units in the neural network do not form a cycle. The feed forward neural network allows data to flow forward (e.g., from the input nodes toward to the output nodes), but the feed forward neural network does not allow data to flow backward (e.g., from the output nodes toward to the input nodes). In an example embodiment, the sequence-based authentication logic 108 employs a feed forward neural network to train a machine learning model that is used to determine ML-based confidences. Such ML-based confidences may be used to determine likelihoods that events will occur.

An LSTM neural network is a recurrent neural network that has memory and allows data to flow forward and backward in the neural network. The LSTM neural network is capable of remembering values for short time periods or long time periods. Accordingly, the LSTM neural network may keep stored values from being iteratively diluted over time. In one example, the LSTM neural network may be capable of storing information, such as attributes of secret sequences and attributes of repeated sequences over time. For instance, the LSTM neural network may generate an authentication model (e.g., a user-specific authentication model) by utilizing such information. In another example, the LSTM neural network may be capable of remembering relationships between features, such as attributes of secret sequences and attributes of repeated sequences, probabilities that the secret sequences correspond to the repeated sequences, and ML-based confidences that are derived therefrom.

In example embodiments, the sequence-based authentication logic 108 includes training logic and inference logic. The training logic is configured to train a machine learning algorithm that the inference logic uses to determine (e.g., infer) the ML-based confidences. For instance, the training logic may provide sample secret sequences (including sample attributes thereof), sample repeated sequences (including sample attributes thereof), sample probabilities that the sample secret sequences correspond to the sample repeated sequences, and sample confidences as inputs to the algorithm to train the algorithm. The sample data may be labeled. The machine learning algorithm may be configured to derive relationships between the features (e.g., secret sequences (including attributes thereof), repeated sequences (including attributes thereof), and probabilities that the secret sequences correspond to the repeated sequences) and the resulting ML-based confidences. The inference logic is configured to utilize the machine learning algorithm, which is trained by the training logic, to determine the ML-based confidence when the features are provided as inputs to the algorithm.

The sequence-based authentication logic 108 may be implemented in various ways to provide sequence-based authentication using rhythm and/or poses, including being implemented in hardware, software, firmware, or any combination thereof. For example, the sequence-based authentication logic 108 may be implemented as computer program code configured to be executed in one or more processors. In another example, at least a portion of the sequence-based authentication logic 108 may be implemented as hardware logic/electrical circuitry. For instance, at least a portion of the sequence-based authentication logic 108 may be implemented in a field-programmable gate array (FPGA), an application-specific integrated circuit (ASIC), an application-specific standard product (ASSP), a system-on-a-chip system (SoC), a complex programmable logic device (CPLD), etc. Each SoC may include an integrated circuit chip that includes one or more of a processor (a microcontroller, microprocessor, digital signal processor (DSP), etc.), memory, one or more communication interfaces, and/or further circuits and/or embedded firmware to perform its functions.

The sequence-based authentication logic 108 is shown to be incorporated in the first server(s) 106A for illustrative purposes and is not intended to be limiting. It will be recognized that the sequence-based authentication logic 108 (or any portion(s) thereof) may be incorporated in any one or more of the user devices 102A-102M. For example, client-side aspects of the sequence-based authentication logic 108 may be incorporated in one or more of the user devices 102A-102M, and server-side aspects of sequence-based authentication logic 108 may be incorporated in the first server(s) 106A. In another example, the sequence-based authentication logic 108 may be distributed among the user devices 102A-102M. In yet another example, the sequence-based authentication logic 108 may be incorporated in a single one of the user devices 102A-102M. In another example, the sequence-based authentication logic 108 may be distributed among the server(s) 106A-106N. In still another example, the sequence-based authentication logic 108 may be incorporated in a single one of the servers 106A-106N.

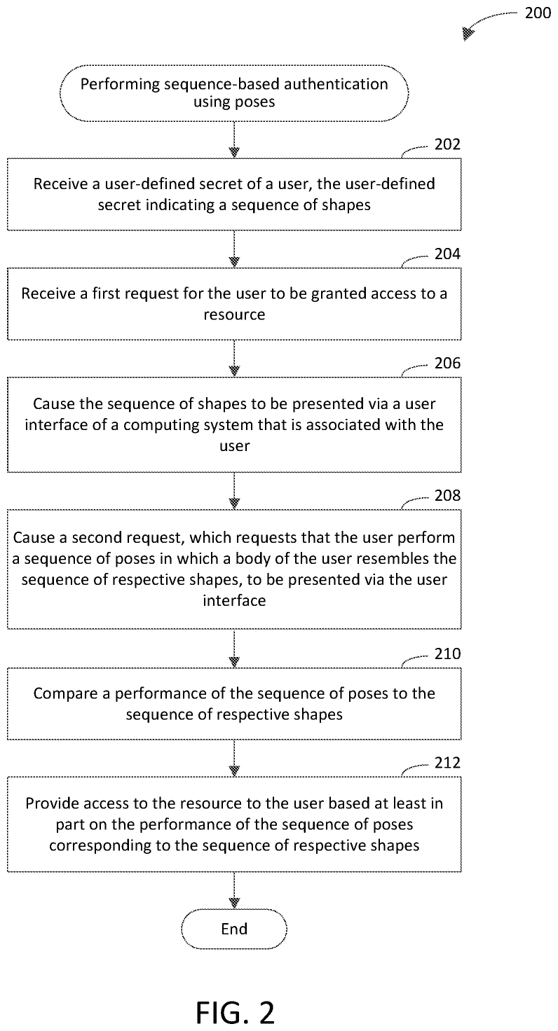

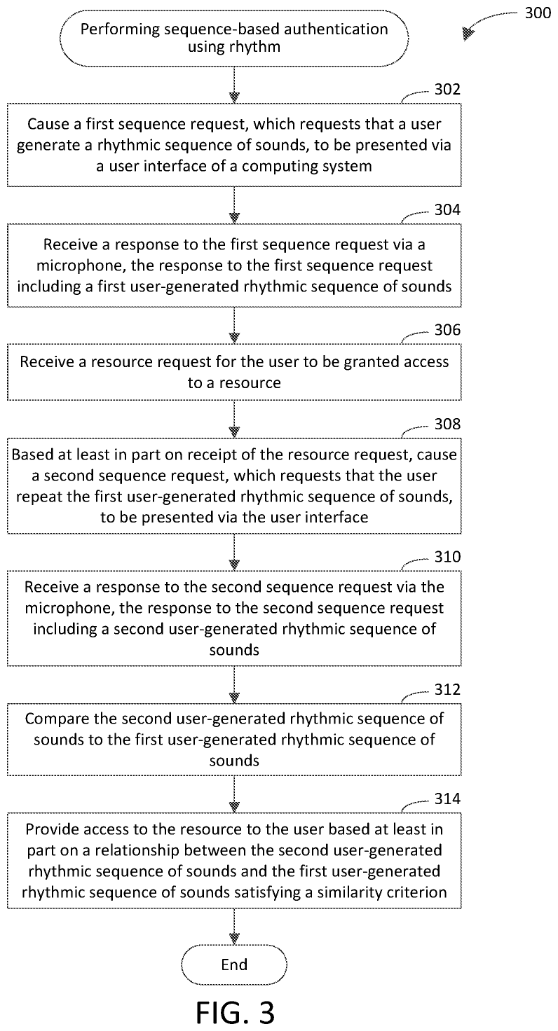

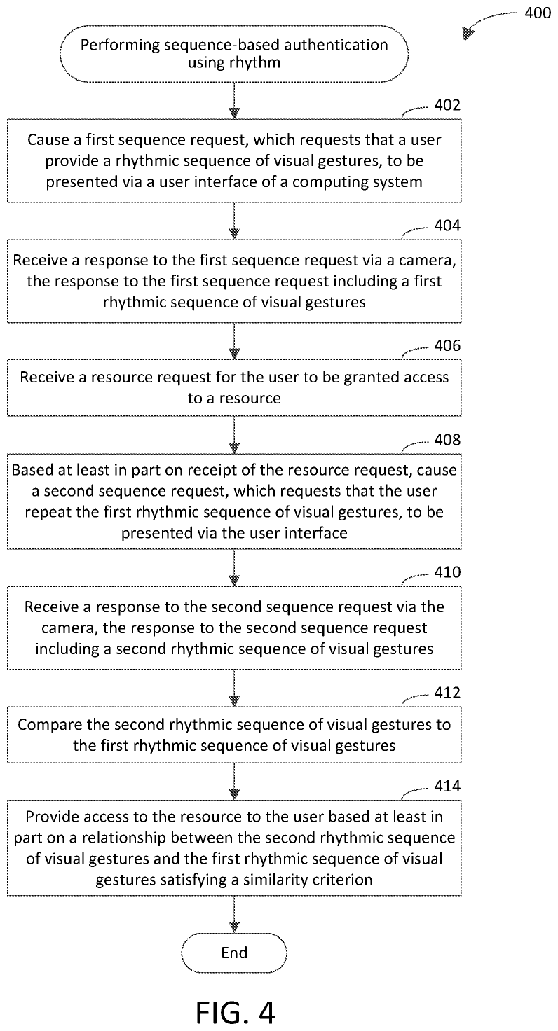

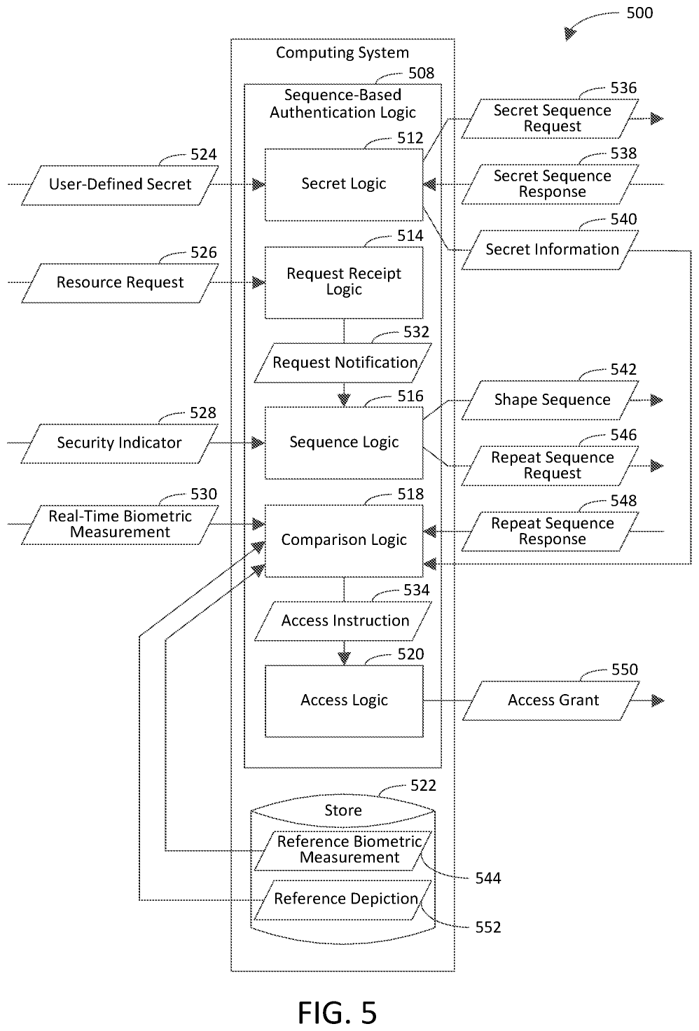

FIG. 2 depicts a flowchart 200 of an example method for performing sequence-based authentication using poses in accordance with an embodiment. FIGS. 3-4 depict flowcharts 300 and 400 of example methods for performing sequence-based authentication using rhythm in accordance with embodiments. Flowcharts 200, 300, and 400 may be performed by the first server(s) 106A shown in FIG. 1, for example. For illustrative purposes, flowcharts 200, 300, and 400 are described with respect to computing system 500 shown in FIG. 5, which is an example implementation of the first server(s) 106A. As shown in FIG. 5, the computing system 500 includes sequence-based authentication logic 508 and a store 522. The sequence-based authentication logic 508 includes secret logic 512, request receipt logic 514, sequence logic 516, comparison logic 518, and access logic 520. The store 522 may be any suitable type of store. One type of store is a database. For instance, the store 522 may be a relational database, an entity-relationship database, an object database, an object relational database, an extensible markup language (XML) database, etc. The store 522 is shown to store a reference biometric measurement 544 and a reference depiction 552 of a sequence of objects for non-limiting, illustrative purposes. Further structural and operational embodiments will be apparent to persons skilled in the relevant art(s) based on the discussion regarding flowcharts 200, 300, and 400.

As shown in FIG. 2, the method of flowchart 200 begins at step 202. In step 202, a user-defined secret of a user is received. The user-defined secret indicates (e.g., specifies) a sequence of shapes. In an example implementation, the secret logic 512 receives a user-defined secret 524 of the user. The user-defined secret 524 indicates the sequence of shapes. The sequence of shapes may include multiple shapes that are selected by the user from a sequence of shapes, and the shapes in the sequence may be in an order that is defined by the user. In accordance with this implementation, the secret logic 512 generates secret information 540 to indicate the sequence of shapes.

At step 204, a first request for the user to be granted access to a resource is received. In an example implementation, the request receipt logic 514 receives a resource request 526, which requests for the user to be granted the access to the resource. The request receipt logic 514 may generate a request notification 532 based on (e.g., based at least in part on) receipt of the resource request 526. The request notification 532 may notify the sequence logic 516 that the user has requested access to the resource.

At step 206, the sequence of shapes is caused to be presented via a user interface of a computing system that is associated with the user. For instance, a sequence of images depicting the sequence of shapes may be presented via the user interface. Each shape in the sequence may be represented by a two-dimensional drawing (e.g., an outline of the shape), a photograph of object(s) (e.g., a hand or a human body) having (e.g., configured to have) the shape, a three-dimensional drawing of the shape, a two-dimensional depiction of a time-based gesture that illustrates the shape, or a three-dimensional depiction of a time-based gesture that illustrates the shape. A time-based gesture is a gesture that is dependent on time. For instance, the gesture may require performing an action for a specified period of time, for at least a specified period of time, or within a specified period of time. In an example implementation, the sequence logic 516 causes a shape sequence 542, which includes the sequence of shapes, to be presented via the user interface. For example, the sequence logic 516 may cause the shape sequence 542 to be presented via the user interface based on receipt of the request notification 532. In accordance with this example, receipt of the request notification 532 may trigger the sequence logic 516 to cause the shape sequence 542 to be presented via the user interface.

In an example local interface embodiment, the computing system 500 includes the user interface. In accordance with this embodiment, the sequence logic 516 may present the shape sequence 542 via the user interface, or the sequence logic 516 may cause a display device that is included in the computing system 500 to present the shape sequence 542 via the user interface that is displayed on the display device.

In an example remote interface embodiment, the computing system that is associated with the user is different from the computing system 500 that performs the method of flowchart 200. In accordance with this embodiment, the sequence logic 516 causes the computing system that is associated with the user to present the shape sequence 542 via the user interface of the computing system that is associated with the user (e.g., by instructing the computing system to present the shape sequence 542 via the user interface).

At step 208, a second request, which requests that the user perform a sequence of poses in which a body of the user resembles the sequence of respective shapes, is caused to be presented via the user interface. Examples of a pose include but are not limited to a hand pose (e.g., a single-hand pose or a double-hand pose), an arm pose, and a full-body pose. A single-hand pose is a hand gesture in which one of a user's hands is configured to form a shape. A double-hand pose is a hand gesture in which both of a user's hands are configured to collaboratively form a shape. An arm pose is a gesture in which one of a user's arms is configured to form a shape or both of the user's arms are configured to collaboratively form the shape. A full-body pose is a gesture in which an entirety of a user's body is configured to form a shape. In an example implementation, the sequence logic 516 causes a repeat sequence request 546, which includes the second request, to be presented via the user interface. For instance, the sequence logic 516 may cause the repeat sequence request 546 to be presented via the user interface as a result of causing the shape sequence 542 to be presented via the user interface. In the example local interface embodiment mentioned above, the sequence logic 516 may present the repeat sequence request 546 via the user interface, or the sequence logic 516 may cause a display device in the computing system 500 to present the repeat sequence request 546 via the user interface that is displayed on the display device. In the example remote interface embodiment mentioned above, the sequence logic 516 causes the computing system that is associated with the user to present the repeat sequence request 546 via the user interface of the computing system that is associated with the user (e.g., by instructing the computing system to present the repeat sequence request 546 via the user interface).

At step 210, a performance of the sequence of poses is compared to the sequence of respective shapes. In an example implementation, the comparison logic 518 compares the performance of the sequence of poses to the sequence of respective shapes. For example, the comparison logic 518 may receive a repeat sequence response 548, which includes a representation of the performance of the sequence of poses. For instance, the comparison logic 518 may receive the repeat sequence response 548 via a camera (e.g., a visible-spectrum camera, an infrared camera, or other suitable input device that is capable of detecting the poses) of the computing system that is associated with the user. In accordance with this example, the comparison logic 518 may receive secret information 540, which indicates the sequence of shapes, from the secret logic 512. In further accordance with this example, the comparison logic 518 may compare the performance of the sequence of poses, as represented in the repeat sequence response 548, to the sequence of respective shapes, as indicated by the secret information 540. The comparison logic 518 may be configured to generate an access instruction 534 based on the performance of the sequence of poses corresponding to the sequence of respective shapes (and further based on any other requisite criteria being satisfied). The comparison logic 518 may be further configured not to generate the access instruction 534 based on the performance of the sequence of poses not corresponding to the sequence of respective shapes.

At step 212, access to the resource is provided to the user based at least in part on the performance of the sequence of poses corresponding to the sequence of respective shapes. In an example implementation, the access logic 520 provides (e.g., grants) the access to the resource to the user based at least in part on the performance of the sequence of poses corresponding to the sequence of respective shapes. For instance, the access logic 520 may provide an access grant 550, which enables the user to access the resource, based on receipt of the access instruction 534 form the comparison logic 518.

In some example embodiments, one or more steps 202, 204, 206, 208, 210, and/or 212 of flowchart 200 may not be performed. Moreover, steps in addition to or in lieu of steps 202, 204, 206, 208, 210, and/or 212 may be performed. For instance, in an example embodiment, the method of flowchart 200 further includes causing a third request to be presented via the user interface. The third request requests that the user present a sequence of objects in a field of view of a camera. In an example implementation, the sequence logic 516 causes the third request to be presented via the user interface. For instance, the sequence logic 516 may include the third request in the repeat sequence request 546. In accordance with this embodiment, the method of flowchart 200 further includes comparing a depiction of the sequence of objects, which is captured by the camera, to a reference depiction of the sequence of objects. In an example implementation, the comparison logic 518 compares the depiction of the sequence of objects to the reference depiction 522 of the sequence of objects. For instance, the repeat sequence response 548, which is received by the comparison logic 518, may include the depiction of the sequence of objects, which is captured by the camera. In further accordance with this embodiment, providing the access to the resource to the user at step 212 is further based at least in part on the depiction of the sequence of objects, which is captured by the camera, corresponding to the reference depiction of the sequence of objects.

In another example embodiment, the method of flowchart 200 further includes receiving a security indicator, which indicates that an amount of security to be applied to the computing system is less than a threshold amount. In an example implementation, the sequence logic 518 receives a security indicator 528, which indicates that the amount of security to be applied to the computing system is less than the threshold amount. In accordance with this embodiment, causing the second request to be presented via the user interface at step 208 is based at least in part on the security indicator indicating that the amount of security to be applied to the computing system is less than the threshold amount.

In yet another example embodiment, the method of flowchart 200 further includes selecting a number of poses in the sequence of poses based at least in part on an age of the user. For instance, the age of the user may be determined based on the user indicating the user's age while opening an account with a service or registering software with a provider of the software. In an example implementation, the sequence logic 516 selects the number of poses in the sequence of poses based at least in part on the age of the user. In accordance with this embodiment, a relatively lower age corresponds to a relatively lower number of poses in the sequence of poses, and a relatively higher age corresponds to a relatively higher number of poses in the sequence of poses.

In still another example embodiment, the first request is received at step 204 from the computing system that is associated with the user. For instance, a determination may be made that the first request is received from a particular computing system based on a header in the first request indicating that the source of the first request is the computing system. For example, the header may indicate an Internet Protocol (IP) address associated with the computing system. In an aspect of this embodiment, the method of flowchart 200 further includes determining that the user is associated with the computing system based at least in part on the computing system being used to log-in the user to a service. Accordingly, by linking the first request to the computing system and by linking the computing system to the user as described above, a determination may be made that the first request is received from the computing system that is associated with the user. In accordance with this embodiment, the access to the resource is provided to the user at step 212 without requiring multi-factor authentication of the user, based at least in part on the first request being received from the computing system that is associated with the user. Multi-factor authentication (MFA) is authentication in which an assertion that an entity is the user includes two or more factors. Each factor may include something the user knows (e.g., only the user knows), something the user has (e.g., only the user has), or something the user is (e.g., only the user is). Examples of something the user knows include but are not limited to a username, a password, a personal identification number (PIN), and a transaction authentication number (TAN). Examples of something the user has include but are not limited to a personal digital assistant, a mobile phone, a hardware token, and a FIDO token. Examples of something the user is include but are not limited to a fingerprint, an eye iris, a face identifier (ID), and a voice.

In another example embodiment, the method of flowchart 200 further includes obtaining a real-time biometric measurement of the user as a result of the first request being received. A biometric measurement is a measurement or calculation of a physiological characteristic of a user. Examples of a physiological characteristic of a user include but are not limited to a face, hand, palm veins, palmprint, fingerprint, DNA, iris, and retina of the user. A measurement or calculation of a characteristic may indicate one or more dimensions of the characteristic (e.g., one or more dimensions of a feature of the characteristic or a spacing between multiple features of the characteristic). For instance, if a physiological characteristic of a user is the user's fingerprint, the biometric factor associated with the user's fingerprint may include a mapping of the ridges in the fingerprint. In an example implementation, the comparison logic 518 obtains a real-time biometric measurement 530 of the user based on receipt of the resource request 526. In accordance with this embodiment, the method of flowchart 200 further includes comparing the real-time biometric measurement to a reference biometric measurement associated with the user. In an example implementation, the comparison logic 518 compares the real-time biometric measurement 530 to the reference biometric measurement 544, which is associated with the user. In further accordance with this embodiment, providing the access to the resource to the user at step 212 is further based at least in part on the real-time biometric measurement of the user corresponding to the reference biometric measurement. For instance, a determination may be made that the real-time biometric measurement of the user corresponds to the reference biometric measurement based on a similarity between the real-time biometric measurement of the user and the reference biometric measurement satisfying a second similarity criterion.

As shown in FIG. 3, the method of flowchart 300 begins at step 302. In step 302, a first sequence request, which requests that a user generate (e.g., speak, sing, clap, or tap) a rhythmic sequence of sounds, is caused to be presented via a user interface of a computing system. In an example implementation, the secret logic 512 causes a secret sequence request 536, which includes the first sequence request, to be presented via the user interface of the computing system.

In an example local interface embodiment, the computing system that includes the user interface is the computing system 500. In accordance with this embodiment, the secret logic 512 may present the secret sequence request 536 via the user interface, or the secret logic 512 may cause a display device that is included in the computing system 500 to present the secret sequence request 536 via the user interface that is displayed on the display device.

In an example remote interface embodiment, the computing system that includes the user interface is different from the computing system 500. In accordance with this embodiment, the secret logic 512 causes the computing system to present the secret sequence request 536 via the user interface of the computing system (e.g., by instructing the computing system to present the secret sequence request 536 via the user interface).

At step 304, a response to the first sequence request is received via a microphone. For instance, the microphone may be included in the computing system that includes the user interface. The response to the first sequence request includes a first user-generated rhythmic sequence of sounds. Each sound in the first user-generated rhythmic sequence of sounds may be spoken (e.g., sung), clapped, or tapped (e.g., with a finger, hand, or foot of the user). In a speaking embodiment, the first user-generated rhythmic sequence is a spoken rhythmic sequence of sounds, meaning that the sounds in the first user-generated rhythmic sequence are spoken. In a clapping embodiment, the first user-generated rhythmic sequence is a clapped rhythmic sequence of sounds, meaning that the sounds in the first user-generated rhythmic sequence are clapped. In a tapping embodiment, the first user-generated rhythmic sequence is a tapped rhythmic sequence of sounds, meaning that the sounds in the first user-generated rhythmic sequence are tapped. In an example implementation, the secret logic 512 receives a secret sequence response 538, which includes the response to the first sequence request, via the microphone. The secret logic 512 may generate secret information 540 to indicate the first user-generated rhythmic sequence of sounds.

At step 306, a resource request for the user to be granted access to a resource is received. In an example implementation, the request receipt logic 514 receives a resource request 526, which requests that the user be granted the access to the resource. The request receipt logic 514 may generate a request notification 532 based on (e.g., based at least in part on) receipt of the resource request 526. The request notification 532 may notify the sequence logic 516 that the user has requested access to the resource.

At step 308, based at least in part on receipt of the resource request, a second sequence request, which requests that the user repeat the first user-generated rhythmic sequence of sounds, is caused to be presented via the user interface. In an example implementation, based at least in part on receipt of the resource request 526, the sequence logic 516 causes a repeat sequence request 546, which includes the second sequence request, to be presented via the user interface. In the example local interface embodiment mentioned above, the sequence logic 516 may present the repeat sequence request 546 via the user interface, or the sequence logic 516 may cause a display device in the computing system 500 to present the repeat sequence request 546 via the user interface that is displayed on the display device. In the example remote interface embodiment mentioned above, the sequence logic 516 causes the computing system to present the repeat sequence request 546 via the user interface of the computing system (e.g., by instructing the computing system to present the repeat sequence request 546 via the user interface).

At step 310, a response to the second sequence request is received via the microphone. The response to the second sequence request includes a second user-generated rhythmic sequence of sounds. Each sound in the second user-generated rhythmic sequence of sounds may be spoken (e.g., sung), clapped, or tapped (e.g., with a finger, hand, or foot of the user). In the speaking embodiment mentioned above, the second user-generated rhythmic sequence is a spoken rhythmic sequence of sounds, meaning that the sounds in the second user-generated rhythmic sequence are spoken. In the clapping embodiment mentioned above, the second user-generated rhythmic sequence is a clapped rhythmic sequence of sounds, meaning that the sounds in the second user-generated rhythmic sequence are clapped. In the tapping embodiment mentioned above, the second user-generated rhythmic sequence is a tapped rhythmic sequence of sounds, meaning that the sounds in the second user-generated rhythmic sequence are tapped. In an example implementation, the comparison logic 518 receives a repeat sequence response 548, which includes the response to the second sequence request, via the microphone.

In an example embodiment, the first user-generated rhythmic sequence of sounds includes a first spoken recitation of a name of the user. In accordance with this embodiment, the second user-generated rhythmic sequence of sounds includes a second spoken recitation of the name of the user.

In another example embodiment, the first user-generated rhythmic sequence of sounds includes a first sung recitation of lyrics of a song. In accordance with this embodiment, the second user-generated rhythmic sequence of sounds includes a second sung recitation of the lyrics of the song. In an aspect of this example, the access to the resource is provided to the user at step 314 further based at least in part on a difference between the second user-generated rhythmic sequence of sounds and the first user-generated rhythmic sequence of sounds satisfying a difference criterion. The difference satisfying the difference criterion indicates that the second user-generated rhythmic sequence of sounds is not a recording of the first user-generated rhythmic sequence of sounds. Accordingly, the difference satisfying the difference criterion may indicate that the second user-generated rhythmic sequence of sounds is generated by a human. For instance, the difference criterion may require that a difference between an attribute of the second user-generated rhythmic sequence of sounds and a corresponding attribute of the first user-generated rhythmic sequence of sounds is greater than or equal to a difference threshold. Examples of an attribute include but are not limited to a frequency of a sound, a duration of a sound, and a temporal separation between a sound and another sound.

At step 312, the second user-generated rhythmic sequence of sounds is compared to the first user-generated rhythmic sequence of sounds. In an example implementation, the comparison logic 518 compares the second user-generated rhythmic sequence of sounds to the first user-generated rhythmic sequence of sounds. For example, the comparison logic 518 may receive secret information 540, which indicates the first user-generated rhythmic sequence of sounds, from the secret logic 512. In accordance with this example, the comparison logic 518 may compare the second user-generated rhythmic sequence of sounds, which is included in the repeat sequence response 548, to the first user-generated rhythmic sequence of sounds, as indicated by the secret information 540, to determine a similarity between the second user-generated rhythmic sequence of sounds and the first user-generated rhythmic sequence of sounds. For instance, the similarity between the second user-generated rhythmic sequence of sounds and the first user-generated rhythmic sequence of sounds may be based at least in part on a similarity between a relative temporal separation between sounds in the second user-generated rhythmic sequence of sounds and a relative temporal separation between sounds in the first user-generated rhythmic sequence of sounds. In an example embodiment, a tempo of the second user-generated rhythmic sequence of sounds and a tempo of the first user-generated rhythmic sequence of sounds are ignored for purposes of determining the similarity. In another example embodiment, the aforementioned tempos are taken into consideration for purposes of determining the similarity. In yet another example embodiment, a timbre of the sounds in the second user-generated rhythmic sequence and a timbre of the sounds in the first user-generated rhythmic sequence are ignored for purposes of determining the similarity. In still another example embodiment, the aforementioned timbres are taken into consideration for purposes of determining the similarity. The comparison logic 518 may be configured to generate an access instruction 534 based on the similarity between the second user-generated rhythmic sequence of sounds and the first user-generated rhythmic sequence of sounds satisfying a similarity criterion (and further based on any other requisite criteria being satisfied). The comparison logic 518 may be further configured not to generate the access instruction 534 based on the similarity between the second user-generated rhythmic sequence of sounds and the first user-generated rhythmic sequence of sounds not satisfying the similarity criterion.

At step 314, access to the resource is provided to the user based at least in part on a similarity between the second user-generated rhythmic sequence of sounds and the first user-generated rhythmic sequence of sounds satisfying a similarity criterion. For instance, the similarity criterion may require that a difference between the second user-generated rhythmic sequence of sounds and the first user-generated rhythmic sequence of sounds is less than or equal to a threshold difference and/or that a probability that the second user-generated rhythmic sequence of sounds does not represent the first user-generated rhythmic sequence of sounds is less than or equal to a threshold probability. In an example implementation, the access logic 520 provides (e.g., grants) the access to the resource to the user based at least in part on the similarity between the second user-generated rhythmic sequence of sounds and the first user-generated rhythmic sequence of sounds satisfying the similarity criterion. For instance, the access logic 520 may provide an access grant 550, which enables the user to access the resource, based on receipt of the access instruction 534 form the comparison logic 518.

In an example embodiment, providing the access to the resource to the user at step 314 is further based at least in part on a frequency distribution of the response to the second sequence request corresponding to a frequency distribution of the response to the first sequence request.

In another example embodiment, the resource request is received at step 306 from the computing system, which is associated with the user. In accordance with this embodiment, the access to the resource is provided to the user at step 314 without requiring multi-factor authentication of the user, based at least in part on the resource request being received from the computing system, which is associated with the user.

In some example embodiments, one or more steps 302, 304, 306, 308, 310, 312, and/or 314 of flowchart 300 may not be performed. Moreover, steps in addition to or in lieu of steps 302, 304, 306, 308, 310, 312, and/or 314 may be performed. For instance, in an example embodiment, the response to the first sequence request is received at step 304 further via a camera. In accordance with this embodiment, the response to the first sequence request further includes a first rhythmic sequence of visual gestures in synchrony with the first user-generated rhythmic sequence of sounds. In further accordance with this example embodiment, the response to the second sequence request is received at step 310 further via the camera. For instance, the camera may be a visible-spectrum camera, an infrared camera, or any other suitable input device that is capable of detecting the visual gestures. In further accordance with this embodiment, the response to the second sequence request further includes a second rhythmic sequence of visual gestures in synchrony with the second user-generated rhythmic sequence of sounds. In further accordance with this embodiment, the method of flowchart 300 further includes comparing the first rhythmic sequence of visual gestures and the second rhythmic sequence of visual gestures. For instance, the comparison logic 528 may compare the first rhythmic sequence of visual gestures and the second rhythmic sequence of visual gestures. In further accordance with this embodiment, providing the access to the resource to the user at step 314 is further based at least in part on the second rhythmic sequence of visual gestures corresponding to the first rhythmic sequence of visual gestures.

In another example embodiment, the method of flowchart 300 further includes receiving a security indicator, which indicates that an amount of security to be applied to the computing system is less than a threshold amount. For example, the sequence logic 516 may receive a security indicator 528, which indicates that the amount of security to be applied to the computing system is less than the threshold amount. In accordance with this embodiment, the second sequence request is caused to be presented via the user interface at step 308 based at least in part on the security indicator indicating that the amount of security to be applied to the computing system is less than the threshold amount. For instance, the sequence logic 516 may cause the repeat sequence request 546, which includes the second sequence request, to be presented via the user interface based at least in part on the security indicator 528 indicating that the amount of security to be applied to the computing system is less than the threshold amount.

In yet another example embodiment, the method of flowchart 300 further includes selecting a complexity of the rhythmic sequence of sounds based at least in part on an age of the user. In accordance with this embodiment, a relatively lower age corresponds to a relatively lower complexity of the rhythmic sequence, and a relatively higher age corresponds to a relatively higher complexity of the rhythmic sequence. For instance, the complexity of the rhythmic sequence may be based on a number of sounds in the rhythmic sequence of sounds, a tempo of the rhythmic sequence of sounds, and/or a frequency range of the rhythmic sequence of sounds.

As shown in FIG. 4, the method of flowchart 400 begins at step 402. In step 402, a first sequence request, which requests that a user provide a rhythmic sequence of visual gestures, is caused to be presented via a user interface of a computing system. In an example implementation, the secret logic 512 causes a secret sequence request 536, which includes the first sequence request, to be presented via the user interface of the computing system.

In an example local interface embodiment, the computing system that includes the user interface is the computing system 500. In accordance with this embodiment, the secret logic 512 may present the secret sequence request 536 via the user interface, or the secret logic 512 may cause a display device that is included in the computing system 500 to present the secret sequence request 536 via the user interface that is displayed on the display device.

In an example remote interface embodiment, the computing system that includes the user interface is different from the computing system 500. In accordance with this embodiment, the secret logic 512 causes the computing system to present the secret sequence request 536 via the user interface of the computing system (e.g., by instructing the computing system to present the secret sequence request 536 via the user interface).

At step 404, a response to the first sequence request is received via a camera. The response to the first sequence request includes a first rhythmic sequence of visual gestures. For example, the camera may be a visible-spectrum camera, an infrared camera, or any other suitable input device that is capable of detecting the visual gestures. In another example, the camera may be included in the computing system that includes the user interface. In an example implementation, the secret logic 512 receives a secret sequence response 538, which includes the response to the first sequence request, via the camera. The secret logic 512 may generate secret information 540 to indicate the first rhythmic sequence of visual gestures.

At step 406, a resource request for the user to be granted access to a resource is received. In an example implementation, the request receipt logic 514 receives a resource request 526, which requests that the user be granted the access to the resource. The request receipt logic 514 may generate a request notification 532 based on (e.g., based at least in part on) receipt of the resource request 526. The request notification 532 may notify the sequence logic 516 that the user has requested access to the resource.

At step 408, based at least in part on receipt of the resource request, a second sequence request, which requests that the user repeat the first rhythmic sequence of visual gestures, is caused to be presented via the user interface. In an example implementation, based at least in part on receipt of the resource request 526, the sequence logic 516 causes a repeat sequence request 546, which includes the second sequence request, to be presented via the user interface. In the example local interface embodiment mentioned above, the sequence logic 516 may present the repeat sequence request 546 via the user interface, or the sequence logic 516 may cause a display device in the computing system 500 to present the repeat sequence request 546 via the user interface that is displayed on the display device. In the example remote interface embodiment mentioned above, the sequence logic 516 causes the computing system to present the repeat sequence request 546 via the user interface of the computing system (e.g., by instructing the computing system to present the repeat sequence request 546 via the user interface).

At step 410, a response to the second sequence request is received via the camera. The response to the second sequence request includes a second rhythmic sequence of visual gestures. In an example implementation, the comparison logic 518 receives a repeat sequence response 548, which includes the response to the second sequence request, via the camera.

At step 412, the second rhythmic sequence of visual gestures is compared to the first rhythmic sequence of visual gestures. In an example implementation, the comparison logic 518 compares the second rhythmic sequence of visual gestures to the first rhythmic sequence of visual gestures. For example, the comparison logic 518 may receive secret information 540, which indicates the first rhythmic sequence of visual gestures, from the secret logic 512. In accordance with this example, the comparison logic 518 may compare the second rhythmic sequence of visual gestures, which is included in the repeat sequence response 548, to the first rhythmic sequence of visual gestures, as indicated by the secret information 540, to determine a similarity between the second rhythmic sequence of visual gestures and the first rhythmic sequence of visual gestures. The comparison logic 518 may be configured to generate an access instruction 534 based on the similarity between the second rhythmic sequence of visual gestures and the first rhythmic sequence of visual gestures satisfying a similarity criterion (and further based on any other requisite criteria being satisfied). The comparison logic 518 may be further configured not to generate the access instruction 534 based on the similarity between the second rhythmic sequence of visual gestures and the first rhythmic sequence of visual gestures not satisfying the similarity criterion.

At step 414, access to the resource is provided to the user based at least in part on a similarity between the second rhythmic sequence of visual gestures and the first rhythmic sequence of visual gestures satisfying a similarity criterion. For instance, the similarity criterion may require that a difference between the second rhythmic sequence of visual gestures and the first rhythmic sequence of visual gestures is less than or equal to a threshold difference and/or that a probability that the second rhythmic sequence of visual gestures does not represent the first rhythmic sequence of visual gestures is less than or equal to a threshold probability. In an example implementation, the access logic 520 provides (e.g., grants) the access to the resource to the user based at least in part on the similarity between the second rhythmic sequence of visual gestures and the first rhythmic sequence of visual gestures satisfying the similarity criterion. For instance, the access logic 520 may provide an access grant 550, which enables the user to access the resource, based on receipt of the access instruction 534 form the comparison logic 518.

In an example embodiment, the access to the resource is provided to the user at step 414 further based at least in part on a tempo of the second rhythmic sequence of visual gestures corresponding to a tempo of the first rhythmic sequence of visual gestures. For instance, the tempo of the second rhythmic sequence of visual gestures may be deemed to correspond to the tempo of the first rhythmic sequence of visual gestures based on a difference between the tempo of the second rhythmic sequence of visual gestures and the tempo of the first rhythmic sequence of visual gestures being less than or equal to a threshold difference.

In another example embodiment, the access to the resource is provided to the user at step 414 based at least in part on a similarity between a first head gesture in the first rhythmic sequence of visual gestures and a second head gesture in the second rhythmic sequence of visual gestures satisfying a similarity criterion.

In yet another example embodiment, the access to the resource is provided to the user at step 414 based at least in part on a similarity between a first hand gesture in the first rhythmic sequence of visual gestures and a second hand gesture in the second rhythmic sequence of visual gestures satisfying a second similarity criterion.

In still another example embodiment, the resource request is received at step 406 from the computing system, which is associated with the user. In an example embodiment, the access to the resource is provided to the user at step 414 without requiring multi-factor authentication of the user based at least in part on the resource request being received from the computing system, which is associated with the user.

In some example embodiments, one or more steps 402, 404, 406, 408, 410, 412, and/or 414 of flowchart 400 may not be performed. Moreover, steps in addition to or in lieu of steps 402, 404, 406, 408, 410, 412, and/or 414 may be performed. For instance, in an example embodiment, the method of flowchart 400 further includes receiving a security indicator, which indicates that an amount of security to be applied to the computing system is less than a threshold amount. For example, the sequence logic 516 may receive a security indicator 528, which indicates that the amount of security to be applied to the computing system is less than the threshold amount. In accordance with this embodiment, the second sequence request is caused to be presented via the user interface at step 408 based at least in part on the security indicator indicating that the amount of security to be applied to the computing system is less than the threshold amount. For instance, the sequence logic 516 may cause the repeat sequence request 546, which includes the second sequence request, to be presented via the user interface based at least in part on the security indicator 528 indicating that the amount of security to be applied to the computing system is less than the threshold amount.

In another example embodiment, the method of flowchart 400 further includes selecting a complexity of the rhythmic sequence of visual gestures based at least in part on an age of the user. In accordance with this embodiment, a relatively lower age corresponds to a relatively lower complexity of the rhythmic sequence of visual gestures, and a relatively higher age corresponds to a relatively higher complexity of the rhythmic sequence of visual gestures. For instance, the complexity of the rhythmic sequence of visual gestures may be based on a number of visual gestures in the rhythmic sequence of visual gestures and/or a tempo of the rhythmic sequence of visual gestures.

It will be recognized that any two or more of the example authentication techniques described above with reference to flowcharts 200, 300, and 400 may be combined. It will be further recognized that any of the aforementioned authentication techniques may utilize other factor(s) (e.g., picture passwords, emoji passwords, color selection, quick response (QR) identifiers, and/or rhythmic sequences that are based on touch rather than sound or visual gestures) to provide a multi-factor authentication solution. For picture passwords, the user may be required to repeat a secret picture password in order to gain access to a resource. For emoji passwords, the user may be required to repeat a secret emoji password in order to gain access to the resource. For color selection, the user may be required to identify a secret color or combination (e.g., sequence) of colors in order to gain access to the resource. For QR identifiers, the user may be required to present a secret QR identifier in order to gain access to the resource. For other types of rhythmic sequences, the user may be required to repeat a secret rhythmic sequence in order to gain access to the resource.

In some example embodiments, a selection menu that identifies multiple authentication techniques (e.g., factors) is presented to the user, enabling the user to select any one or more of the authentication techniques to be used for authenticating the user. For example, the selection menu may include multiple selectable interface elements corresponding to the respective authentication techniques. Examples of an interface element include but are not limited to a virtual button and an item in a pulldown menu. In accordance with this example, selection of an interface element causes the respective authentication technique to be added as a factor to be employed when authenticating the user. An inquiry may be presented to the user, requesting the user to provide a secret for each selected authentication technique. The secret for each selected authentication technique may be received in response to the inquiry. The received secrets may be stored for subsequent use when authenticating the user.

Any of the example authentication techniques described above with reference to flowcharts 200, 300, and 400 may be triggered based on a security event, though the example embodiments are not limited in this respect. Examples of a security event include but are not limited to the user attempting to log-in to a system (e.g., service) from an unusual (e.g., unknown or rarely-used) location, device, or Internet Protocol (IP) address; credential(s) of the user being detected on the dark web; and the user attempting to log-in from two different locations that are relatively far apart within a relatively short period of time.

Any of the example authentication techniques described above with reference to flowcharts 200, 300, and 400 may be used to re-gain access to an account that has been locked, though the example embodiments are not limited in this respect.

It will be recognized that the computing system 500 may not include one or more of the sequence-based authentication logic 508, the secret logic 512, the request receipt logic 514, the sequence logic 516, the comparison logic 518, the access logic 520, and/or the store 522. Furthermore, the computing system 500 may include components in addition to or in lieu of the sequence-based authentication logic 508, the secret logic 512, the request receipt logic 514, the sequence logic 516, the comparison logic 518, the access logic 520, and/or the store 522.

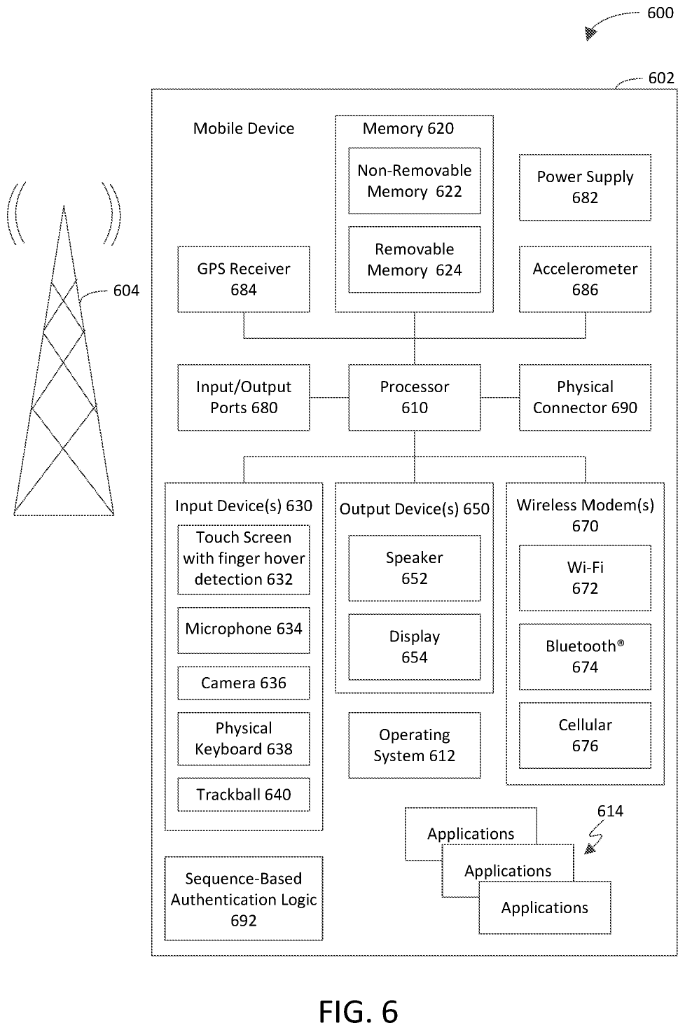

FIG. 6 is a system diagram of an example mobile device 600 including a variety of optional hardware and software components, shown generally as 602. Any components 602 in the mobile device may communicate with any other component, though not all connections are shown, for ease of illustration. The mobile device 600 may be any of a variety of computing devices (e.g., cell phone, smartphone, handheld computer, Personal Digital Assistant (PDA), etc.) and may allow wireless two-way communications with one or more mobile communications networks 604, such as a cellular or satellite network, or with a local area or wide area network.

The mobile device 600 includes a processor 610 (e.g., signal processor, microprocessor, ASIC, or other control and processing logic circuitry) for performing such tasks as signal coding, data processing, input/output processing, power control, and/or other functions. An operating system 612 may control the allocation and usage of the components 602 and support for one or more applications 614 (a.k.a. application programs). The applications 614 may include common mobile computing applications (e.g., email applications, calendars, contact managers, web browsers, messaging applications) and any other computing applications (e.g., word processing applications, mapping applications, media player applications).

The mobile device 600 includes sequence-based authentication logic 692, which is operable in a manner similar to the sequence-based authentication logic 108 described above with reference to FIG. 1 and/or the sequence-based authentication logic 508 described above with reference to FIG. 5.

The mobile device 600 includes memory 620. The memory 620 may include non-removable memory 622 and/or removable memory 624. The non-removable memory 622 may include random access memory (RAM), read-only memory (ROM), flash memory, a hard disk, or other well-known memory storage technologies. The removable memory 624 may include flash memory or a Subscriber Identity Module (SIM) card, which is well known in Global System for Mobile Communications (GSM) systems, or other well-known memory storage technologies, such as “smart cards.” The memory 620 may store data and/or code for running the operating system 612, the applications 614, and the sequence-based authentication logic 692. Example data may include web pages, text, images, sound files, video data, or other data sets to be sent to and/or received from one or more network servers or other devices via one or more wired or wireless networks. Memory 620 may store a subscriber identifier, such as an International Mobile Subscriber Identity (IMSI), and an equipment identifier, such as an International Mobile Equipment Identifier (IMEI). Such identifiers may be transmitted to a network server to identify users and equipment.

The mobile device 600 may support one or more input devices 630, such as a touch screen 632, microphone 634, camera 636, physical keyboard 638 and/or trackball 640 and one or more output devices 650, such as a speaker 652 and a display 654. Touch screens, such as the touch screen 632, may detect input in different ways. For example, capacitive touch screens detect touch input when an object (e.g., a fingertip) distorts or interrupts an electrical current running across the surface. As another example, touch screens may use optical sensors to detect touch input when beams from the optical sensors are interrupted. Physical contact with the surface of the screen is not necessary for input to be detected by some touch screens. For example, the touch screen 632 may support a finger hover detection using capacitive sensing, as is well understood. Other detection techniques may be used, including camera-based detection and ultrasonic-based detection. To implement a finger hover, a user's finger is typically within a predetermined spaced distance above the touch screen, such as between 0.1 to 0.25 inches, or between 0.25 inches and 0.5 inches, or between 0.5 inches and 0.75 inches, or between 0.75 inches and 1 inch, or between 1 inch and 1.5 inches, etc.

Other possible output devices (not shown) may include piezoelectric or other haptic output devices. Some devices may serve more than one input/output function. For example, touch screen 632 and display 654 may be combined in a single input/output device. The input devices 630 may include a Natural User Interface (NUI). An NUI is any interface technology that enables a user to interact with a device in a “natural” manner, free from artificial constraints imposed by input devices such as mice, keyboards, remote controls, and the like. Examples of NUI methods include those relying on speech recognition, touch and stylus recognition, gesture recognition both on screen and adjacent to the screen, air gestures, head and eye tracking, voice and speech, vision, touch, gestures, and machine intelligence. Other examples of a NUI include motion gesture detection using accelerometers/gyroscopes, facial recognition, 3D displays, head, eye, and gaze tracking, immersive augmented reality and virtual reality systems, all of which provide a more natural interface, as well as technologies for sensing brain activity using electric field sensing electrodes (EEG and related methods). Thus, in one specific example, the operating system 612 or applications 614 may include speech-recognition software as part of a voice control interface that allows a user to operate the mobile device 600 via voice commands. Furthermore, the mobile device 600 may include input devices and software that allows for user interaction via a user's spatial gestures, such as detecting and interpreting gestures to provide input to a gaming application.

Wireless modem(s) 670 may be coupled to antenna(s) (not shown) and may support two-way communications between the processor 610 and external devices, as is well understood in the art. The modem(s) 670 are shown generically and may include a cellular modem 676 for communicating with the mobile communication network 604 and/or other radio-based modems (e.g., Bluetooth® 674 and/or Wi-Fi 672). At least one of the wireless modem(s) 670 is typically configured for communication with one or more cellular networks, such as a GSM network for data and voice communications within a single cellular network, between cellular networks, or between the mobile device and a public switched telephone network (PSTN).

The mobile device may further include at least one input/output port 680, a power supply 682, a satellite navigation system receiver 684, such as a Global Positioning System (GPS) receiver, an accelerometer 686, and/or a physical connector 690, which may be a universal serial bus (USB) port, IEEE 1394 (FireWire) port, and/or RS-232 port. The illustrated components 602 are not required or all-inclusive, as any components may be deleted and other components may be added as would be recognized by one skilled in the art.

Although the operations of some of the disclosed methods are described in a particular, sequential order for convenient presentation, it should be understood that this manner of description encompasses rearrangement, unless a particular ordering is required by specific language set forth herein. For example, operations described sequentially may in some cases be rearranged or performed concurrently. Moreover, for the sake of simplicity, the attached figures may not show the various ways in which the disclosed methods may be used in conjunction with other methods.

Any one or more of the sequence-based authentication logic 108, the sequence-based authentication logic 508, the secret logic 512, the request receipt logic 514, the sequence logic 516, the comparison logic 518, the access logic 520, flowchart 200, flowchart 300, and/or flowchart 400 may be implemented in hardware, software, firmware, or any combination thereof.

For example, any one or more of the sequence-based authentication logic 108, the sequence-based authentication logic 508, the secret logic 512, the request receipt logic 514, the sequence logic 516, the comparison logic 518, the access logic 520, flowchart 200, flowchart 300, and/or flowchart 400 may be implemented, at least in part, as computer program code configured to be executed in one or more processors.

In another example, any one or more of the sequence-based authentication logic 108, the sequence-based authentication logic 508, the secret logic 512, the request receipt logic 514, the sequence logic 516, the comparison logic 518, the access logic 520, flowchart 200, flowchart 300, and/or flowchart 400 may be implemented, at least in part, as hardware logic/electrical circuitry. Such hardware logic/electrical circuitry may include one or more hardware logic components. Examples of a hardware logic component include but are not limited to a field-programmable gate array (FPGA), an application-specific integrated circuit (ASIC), an application-specific standard product (ASSP), a system-on-a-chip system (SoC), a complex programmable logic device (CPLD), etc. For instance, a SoC may include an integrated circuit chip that includes one or more of a processor (e.g., a microcontroller, microprocessor, digital signal processor (DSP), etc.), memory, one or more communication interfaces, and/or further circuits and/or embedded firmware to perform its functions.

### III. Further Discussion of Some Example Embodiments

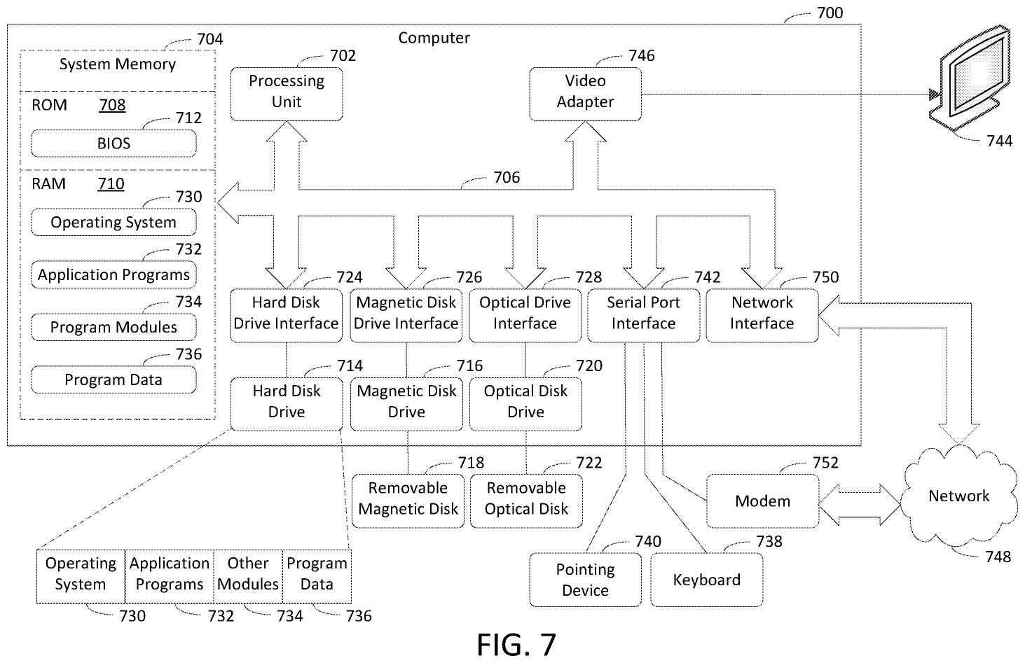

(A1) A first example system (FIG. 1, 102A-102M, 106A-106N; FIG. 5, 500; FIG. 6, 602; FIG. 7, 700) to perform sequence-based authentication using poses comprises a memory (FIG. 6, 620, 622, 624; FIG. 7, 704, 708, 710) and a processing system (FIG. 6, 610; FIG. 7, 702) coupled to the memory. The processing system is configured to receive (FIG. 2, 202) a user-defined secret (FIG. 5, 524) of a user, the user-defined secret indicating a sequence of shapes. The processing system is further configured to receive (FIG. 2, 204) a first request (FIG. 5, 526) for the user to be granted access to a resource (FIG. 1, 110). The processing system is further configured to cause (FIG. 2, 206) the sequence of shapes to be presented via a user interface of a computing system that is associated with the user. The processing system is further configured to cause (FIG. 2, 208) a second request (FIG. 5, 546), which requests that the user perform a sequence of poses in which a body of the user resembles the sequence of respective shapes, to be presented via the user interface. The processing system is further configured to compare (FIG. 2, 210) a performance of the sequence of poses to the sequence of respective shapes. The processing system is further configured to provide (FIG. 2, 212) access to the resource to the user based at least in part on the performance of the sequence of poses corresponding to the sequence of respective shapes.

(A2) In the example system of A1, wherein the processing system is configured to: cause a third request to be presented via the user interface, the third request requesting that the user present a sequence of objects in a field of view of a camera; compare a depiction of the sequence of objects, which is captured by the camera, to a reference depiction of the sequence of objects; and provide the access to the resource to the user further based at least in part on the depiction of the sequence of objects, which is captured by the camera, corresponding to the reference depiction of the sequence of objects.

(A3) In the example system of any of A1-A2, wherein the processing system is configured to: receive a security indicator, which indicates that an amount of security to be applied to the computing system is less than a threshold amount; and cause the second request to be presented via the user interface based at least in part on the security indicator indicating that the amount of security to be applied to the computing system is less than the threshold amount.

(A4) In the example system of any of A1-A3, wherein the processing system is further configured to: select a number of poses in the sequence of poses based at least in part on an age of the user, wherein a relatively lower age corresponds to a relatively lower number of poses in the sequence of poses, and wherein a relatively higher age corresponds to a relatively higher number of poses in the sequence of poses.

(A5) In the example system of any of A1-A4, wherein the processing system is configured to: based at least in part on the first request being received from the computing system that is associated with the user, providing the access to the resource to the user without requiring multi-factor authentication of the user.

(A6) In the example system of any of A1-A5, wherein the processing system is further configured to: determine that the user is associated with the computing system based at least in part on the computing system being used to log-in the user to a service.

(A7) In the example system of any of A1-A6, wherein the processing system is configured to: obtain a real-time biometric measurement of the user as a result of the first request being received; compare the real-time biometric measurement to a reference biometric measurement associated with the user; and providing the access to the resource to the user further based at least in part on the real-time biometric measurement of the user corresponding to the reference biometric measurement.

(B1) A second example system (FIG. 1, 102A-102M, 106A-106N; FIG. 5, 500; FIG. 6, 602; FIG. 7, 700) to perform sequence-based authentication using rhythm comprises a memory (FIG. 6, 620, 622, 624; FIG. 7, 704, 708, 710) and a processing system (FIG. 6, 610; FIG. 7, 702) coupled to the memory. The processing system is configured to cause (FIG. 3, 302) a first sequence request (FIG. 5, 536), which requests that a user generate a rhythmic sequence of sounds, to be presented via a user interface of a computing system. The processing system is further configured to receive (FIG. 3, 304) a response (FIG. 5, 538) to the first sequence request via a microphone. The response to the first sequence request includes a first user-generated rhythmic sequence of sounds. The processing system is further configured to receive (FIG. 3, 306) a resource request (FIG. 5, 526) for the user to be granted access to a resource (FIG. 1, 110). The processing system is further configured to, based at least in part on receipt of the resource request, cause (FIG. 3, 308) a second sequence request (FIG. 5, 546), which requests that the user repeat the first user-generated rhythmic sequence of sounds, to be presented via the user interface. The processing system is further configured to receive (FIG. 3, 310) a response (FIG. 5, 548) to the second sequence request via the microphone. The response to the second sequence request includes a second user-generated rhythmic sequence of sounds. The processing system is further configured to compare (FIG. 3, 312) the second user-generated rhythmic sequence of sounds to the first user-generated rhythmic sequence of sounds. The processing system is further configured to provide (FIG. 3, 314) access to the resource to the user based at least in part on a similarity between the second user-generated rhythmic sequence of sounds and the first user-generated rhythmic sequence of sounds satisfying a similarity criterion.

(B2) In the example system of B1, wherein the processing system is configured to: provide the access to the resource to the user further based at least in part on a frequency distribution of the response to the second sequence request corresponding to a frequency distribution of the response to the first sequence request.

(B3) In the example system of any of B1-B2, wherein the first user-generated rhythmic sequence of sounds includes a first spoken recitation of a name of the user; and wherein the second user-generated rhythmic sequence of sounds includes a second spoken recitation of the name of the user.

(B4) In the example system of any of B1-B3, wherein the first user-generated rhythmic sequence of sounds includes a first sung recitation of lyrics of a song; and wherein the second user-generated rhythmic sequence of sounds includes a second sung recitation of the lyrics of the song.

(B5) In the example system of any of B1-B4, wherein the processing system is configured to: provide the access to the resource to the user further based at least in part on a difference between the second user-generated rhythmic sequence of sounds and the first user-generated rhythmic sequence of sounds satisfying a difference criterion, the difference satisfying the difference criterion indicating that the second user-generated rhythmic sequence of sounds is not a recording of the first user-generated rhythmic sequence of sounds.

(B6) In the example system of any of B1-B5, wherein the processing system is configured to: receive the response to the first sequence request further via a camera, the response to the first sequence request further including a first rhythmic sequence of visual gestures in synchrony with the first user-generated rhythmic sequence of sounds; receive the response to the second sequence request further via the camera, the response to the second sequence request further including a second rhythmic sequence of visual gestures in synchrony with the second user-generated rhythmic sequence of sounds; compare the first rhythmic sequence of visual gestures and the second rhythmic sequence of visual gestures; and provide the access to the resource to the user further based at least in part on the second rhythmic sequence of visual gestures corresponding to the first rhythmic sequence of visual gestures.

(B7) In the example system of any of B1-B6, wherein the processing system is configured to: receive a security indicator, which indicates that an amount of security to be applied to the computing system is less than a threshold amount; and cause the second sequence request to be presented via the user interface further based at least in part on the security indicator indicating that the amount of security to be applied to the computing system is less than the threshold amount.

(B8) In the example system of any of B1-B7, wherein the processing system is further configured to: select a complexity of the rhythmic sequence based at least in part on an age of the user, wherein a relatively lower age corresponds to a relatively lower complexity of the rhythmic sequence, and wherein a relatively higher age corresponds to a relatively higher complexity of the rhythmic sequence.

(B9) In the example system of any of B1-B8, wherein the processing system is configured to: based at least in part on the resource request being received from the computing system, which is associated with the user, provide the access to the resource to the user without requiring multi-factor authentication of the user.

(C1) A third example system (FIG. 1, 102A-102M, 106A-106N; FIG. 5, 500; FIG. 6, 602; FIG. 7, 700) to perform sequence-based authentication using rhythm comprises a memory (FIG. 6, 620, 622, 624; FIG. 7, 704, 708, 710) and a processing system (FIG. 6, 610; FIG. 7, 702) coupled to the memory. The processing system is configured to cause (FIG. 4, 402) a first sequence request (FIG. 5, 536), which requests that a user provide a rhythmic sequence of visual gestures, to be presented via a user interface of a computing system. The processing system is further configured to receive (FIG. 4, 404) a response (FIG. 5, 538) to the first sequence request via a camera. The response to the first sequence request includes a first rhythmic sequence of visual gestures. The processing system is further configured to receive (FIG. 4, 406) a resource request (FIG. 5, 526) for the user to be granted access to a resource (FIG. 1, 110). The processing system is further configured to, based at least in part on receipt of the resource request, cause (FIG. 4, 408) a second sequence request (FIG. 5, 546), which requests that the user repeat the first rhythmic sequence of visual gestures, to be presented via the user interface. The processing system is further configured to receive (FIG. 4, 410) a response (FIG. 5, 548) to the second sequence request via the camera. The response to the second sequence request includes a second rhythmic sequence of visual gestures. The processing system is further configured to compare (FIG. 4, 412) the second rhythmic sequence of visual gestures to the first rhythmic sequence of visual gestures. The processing system is further configured to provide (FIG. 4, 414) access to the resource to the user based at least in part on a similarity between the second rhythmic sequence of visual gestures and the first rhythmic sequence of visual gestures satisfying a similarity criterion.

(C2) In the example system of C1, wherein the processing system is configured to: provide the access to the resource to the user further based at least in part on a tempo of the second rhythmic sequence of visual gestures corresponding to a tempo of the first rhythmic sequence of visual gestures.

(C3) In the example system of any of C1-C2, wherein the processing system is configured to: provide the access to the resource to the user based at least in part on a similarity between a first head gesture in the first rhythmic sequence of visual gestures and a second head gesture in the second rhythmic sequence of visual gestures satisfying a second similarity criterion.

(C4) In the example system of any of C1-C3, wherein the processing system is configured to: provide the access to the resource to the user based at least in part on a similarity between a first hand gesture in the first rhythmic sequence of visual gestures and a second hand gesture in the second rhythmic sequence of visual gestures satisfying a second similarity criterion.

(C5) In the example system of any of C1-C4, wherein the processing system is configured to: receive a security indicator, which indicates that an amount of security to be applied to the computing system is less than a threshold amount; and cause the second sequence request to be presented via the user interface further based at least in part on the security indicator indicating that the amount of security to be applied to the computing system is less than the threshold amount.

(C6) In the example system of any of C1-C5, wherein the processing system is further configured to: select a complexity of the rhythmic sequence of visual gestures based at least in part on an age of the user, wherein a relatively lower age corresponds to a relatively lower complexity of the rhythmic sequence of visual gestures, and wherein a relatively higher age corresponds to a relatively higher complexity of the rhythmic sequence of visual gestures.

(C7) In the example system of any of C1-C6, wherein the processing system is configured to: based at least in part on the resource request being received from the computing system, which is associated with the user, provide the access to the resource to the user without requiring multi-factor authentication of the user.

(D1) A first example method of performing sequence-based authentication using poses. The method is implemented by an authentication computing system (FIG. 1, 102A-102M, 106A-106N; FIG. 5, 500; FIG. 6, 602; FIG. 7, 700). The method comprises receiving (FIG. 2, 202) a user-defined secret (FIG. 5, 524) of a user. The user-defined secret indicates a sequence of shapes. The method further comprises receiving (FIG. 2, 204) a first request (FIG. 5, 526) for the user to be granted access to a resource (FIG. 1, 110). The method further comprises causing (FIG. 2, 206) the sequence of shapes to be presented via a user interface of a computing system that is associated with the user. The method further comprises causing (FIG. 2, 208) a second request (FIG. 5, 546), which requests that the user perform a sequence of poses in which a body of the user resembles the sequence of respective shapes, to be presented via the user interface. The method further comprises comparing (FIG. 2, 210) a performance of the sequence of poses to the sequence of respective shapes. The method further comprises providing (FIG. 2, 212) access to the resource to the user based at least in part on the performance of the sequence of poses corresponding to the sequence of respective shapes.

(D2) In the method of D1, further comprising: causing a third request to be presented via the user interface, the third request requesting that the user present a sequence of objects in a field of view of a camera; and comparing a depiction of the sequence of objects, which is captured by the camera, to a reference depiction of the sequence of objects; wherein providing the access to the resource to the user comprises: providing the access to the resource to the user further based at least in part on the depiction of the sequence of objects, which is captured by the camera, corresponding to the reference depiction of the sequence of objects.

(D3) In the method of any of D1-D2, further comprising: receiving a security indicator, which indicates that an amount of security to be applied to the computing system is less than a threshold amount; wherein causing the second request to be presented via the user interface is based at least in part on the security indicator indicating that the amount of security to be applied to the computing system is less than the threshold amount.

(D4) In the method of any of D1-D3, further comprising: selecting a number of poses in the sequence of poses based at least in part on an age of the user, wherein a relatively lower age corresponds to a relatively lower number of poses in the sequence of poses, and wherein a relatively higher age corresponds to a relatively higher number of poses in the sequence of poses.

(D5) In the method of any of D1-D4, wherein receiving the first request comprises: receiving the first request from the computing system that is associated with the user; and wherein providing the access to the resource to the user comprises: based at least in part on the first request being received from the computing system that is associated with the user, providing the access to the resource to the user without requiring multi-factor authentication of the user.

(D6) In the method of any of D1-D5, further comprising: determining that the user is associated with the computing system based at least in part on the computing system being used to log-in the user to a service.

(D7) In the method of any of D1-D6, further comprising: obtaining a real-time biometric measurement of the user as a result of the first request being received; and comparing the real-time biometric measurement to a reference biometric measurement associated with the user; wherein providing the access to the resource to the user comprises: providing the access to the resource to the user further based at least in part on the real-time biometric measurement of the user corresponding to the reference biometric measurement.

(E1) A second example method of performing sequence-based authentication using rhythm. The method is implemented by an authentication computing system (FIG. 1, 102A-102M, 106A-106N; FIG. 5, 500; FIG. 6, 602; FIG. 7, 700). The method comprises causing (FIG. 3, 302) a first sequence request (FIG. 5, 536), which requests that a user generate a rhythmic sequence of sounds, to be presented via a user interface of a computing system. The method further comprises receiving (FIG. 3, 304) a response (FIG. 5, 538) to the first sequence request via a microphone. The response to the first sequence request includes a first user-generated rhythmic sequence of sounds. The method further comprises receiving (FIG. 3, 306) a resource request (FIG. 5, 526) for the user to be granted access to a resource (FIG. 1, 110). The method further comprises, based at least in part on receipt of the resource request, causing (FIG. 3, 308) a second sequence request (FIG. 5, 546), which requests that the user repeat the first user-generated rhythmic sequence of sounds, to be presented via the user interface. The method further comprises receiving (FIG. 3, 310) a response (FIG. 5, 548) to the second sequence request via the microphone. The response to the second sequence request includes a second user-generated rhythmic sequence of sounds. The method further comprises comparing (FIG. 3, 312) the second user-generated rhythmic sequence of sounds to the first user-generated rhythmic sequence of sounds. The method further comprises providing (FIG. 3, 314) access to the resource to the user based at least in part on a similarity between the second user-generated rhythmic sequence of sounds and the first user-generated rhythmic sequence of sounds satisfying a similarity criterion.

(E2) In the method of E1, wherein providing the access to the resource to the user comprises: providing the access to the resource to the user further based at least in part on a frequency distribution of the response to the second sequence request corresponding to a frequency distribution of the response to the first sequence request.

(E3) In the method of any of E1-E2, wherein the first user-generated rhythmic sequence of sounds includes a first spoken recitation of a name of the user; and wherein the second user-generated rhythmic sequence of sounds includes a second spoken recitation of the name of the user.

(E4) In the method of any of E1-E3, wherein the first user-generated rhythmic sequence of sounds includes a first sung recitation of lyrics of a song; and wherein the second user-generated rhythmic sequence of sounds includes a second sung recitation of the lyrics of the song.

(E5) In the method of any of E1-E4, wherein providing the access to the resource to the user comprises: providing the access to the resource to the user further based at least in part on a difference between the second user-generated rhythmic sequence of sounds and the first user-generated rhythmic sequence of sounds satisfying a difference criterion, the difference satisfying the difference criterion indicating that the second user-generated rhythmic sequence of sounds is not a recording of the first user-generated rhythmic sequence of sounds.

(E6) In the method of any of E1-E5, wherein receiving the response to the first sequence request comprises: receiving the response to the first sequence request further via a camera, the response to the first sequence request further including a first rhythmic sequence of visual gestures in synchrony with the first user-generated rhythmic sequence of sounds; wherein receiving the response to the second sequence request comprises: receiving the response to the second sequence request further via the camera, the response to the second sequence request further including a second rhythmic sequence of visual gestures in synchrony with the second user-generated rhythmic sequence of sounds; wherein the method further comprises: comparing the first rhythmic sequence of visual gestures and the second rhythmic sequence of visual gestures; and wherein providing the access to the resource to the user comprises: providing the access to the resource to the user further based at least in part on the second rhythmic sequence of visual gestures corresponding to the first rhythmic sequence of visual gestures.

(E7) In the method of any of E1-E6, further comprising: receiving a security indicator, which indicates that an amount of security to be applied to the computing system is less than a threshold amount; wherein causing the second sequence request to be presented via the user interface is based at least in part on the security indicator indicating that the amount of security to be applied to the computing system is less than the threshold amount.

(E8) In the method of any of E1-E7, further comprising: selecting a complexity of the rhythmic sequence based at least in part on an age of the user, wherein a relatively lower age corresponds to a relatively lower complexity of the rhythmic sequence, and wherein a relatively higher age corresponds to a relatively higher complexity of the rhythmic sequence.

(E9) In the method of any of E1-E8, wherein receiving the resource request comprises: receiving the resource request from the computing system, which is associated with the user; and wherein providing the access to the resource to the user comprises: based at least in part on the resource request being received from the computing system, which is associated with the user, providing the access to the resource to the user without requiring multi-factor authentication of the user.

(F1) A third example method of performing sequence-based authentication using rhythm. The method is implemented by an authentication computing system (FIG. 1, 102A-102M, 106A-106N; FIG. 5, 500; FIG. 6, 602; FIG. 7, 700). The method comprises causing (FIG. 4, 402) a first sequence request (FIG. 5, 536), which requests that a user provide a rhythmic sequence of visual gestures, to be presented via a user interface of a computing system. The method further comprises receiving (FIG. 4, 404) a response (FIG. 5, 538) to the first sequence request via a camera. The response to the first sequence request includes a first rhythmic sequence of visual gestures. The method further comprises receiving (FIG. 4, 406) a resource request (FIG. 5, 526) for the user to be granted access to a resource (FIG. 1, 110). The method further comprises, based at least in part on receipt of the resource request, causing (FIG. 4, 408) a second sequence request (FIG. 5, 546), which requests that the user repeat the first rhythmic sequence of visual gestures, to be presented via the user interface. The method further comprises receiving (FIG. 4, 410) a response (FIG. 5, 548) to the second sequence request via the camera. The response to the second sequence request including a second rhythmic sequence of visual gestures. The method further comprises comparing (FIG. 4, 412) the second rhythmic sequence of visual gestures to the first rhythmic sequence of visual gestures. The method further comprises providing (FIG. 4, 414) access to the resource to the user based at least in part on a similarity between the second rhythmic sequence of visual gestures and the first rhythmic sequence of visual gestures satisfying a similarity criterion.

(F2) In the method of F1, wherein providing the access to the resource to the user comprises: providing the access to the resource to the user further based at least in part on a tempo of the second rhythmic sequence of visual gestures corresponding to a tempo of the first rhythmic sequence of visual gestures.

(F3) In the method of any of F1-F2, wherein providing the access to the resource to the user comprises: providing the access to the resource to the user based at least in part on a similarity between a first head gesture in the first rhythmic sequence of visual gestures and a second head gesture in the second rhythmic sequence of visual gestures satisfying a similarity criterion.

(F4) In the method of any of F1-F3, wherein providing the access to the resource to the user comprises: providing the access to the resource to the user based at least in part on a similarity between a first hand gesture in the first rhythmic sequence of visual gestures and a second hand gesture in the second rhythmic sequence of visual gestures satisfying a second similarity criterion.

(F5) In the method of any of F1-F4, further comprising: receiving a security indicator, which indicates that an amount of security to be applied to the computing system is less than a threshold amount; wherein causing the second sequence request to be presented via the user interface is based at least in part on the security indicator indicating that the amount of security to be applied to the computing system is less than the threshold amount.

(F6) In the method of any of F1-F5, further comprising: selecting a complexity of the rhythmic sequence of visual gestures based at least in part on an age of the user, wherein a relatively lower age corresponds to a relatively lower complexity of the rhythmic sequence of visual gestures, and wherein a relatively higher age corresponds to a relatively higher complexity of the rhythmic sequence of visual gestures.

(F7) In the method of any of F1-F6, wherein receiving the resource request comprises: receiving the resource request from the computing system, which is associated with the user; and wherein providing the access to the resource to the user comprises: based at least in part on the resource request being received from the computing system, which is associated with the user, providing the access to the resource to the user without requiring multi-factor authentication of the user.

(G1) A first example computer program product (FIG. 6, 624; FIG. 7, 718, 722) comprising a computer-readable storage medium having instructions recorded thereon for enabling a processor-based system (FIG. 1, 102A-102M, 106A-106N; FIG. 5, 500; FIG. 6, 602; FIG. 7, 700) to perform sequence-based authentication using poses by performing operations. The operations comprise receiving (FIG. 2, 202) a user-defined secret (FIG. 5, 524) of a user. The user-defined secret indicates a sequence of shapes. The operations further comprise receiving (FIG. 2, 204) a first request (FIG. 5, 526) for the user to be granted access to a resource (FIG. 1, 110). The operations further comprise causing (FIG. 2, 206) the sequence of shapes to be presented via a user interface of a computing system that is associated with the user. The operations further comprise causing (FIG. 2, 208) a second request (FIG. 5, 546), which requests that the user perform a sequence of poses in which a body of the user resembles the sequence of respective shapes, to be presented via the user interface. The operations further comprise comparing (FIG. 2, 210) a performance of the sequence of poses to the sequence of respective shapes. The operations further comprise providing (FIG. 2, 212) access to the resource to the user based at least in part on the performance of the sequence of poses corresponding to the sequence of respective shapes.

(G2) In the example computer program product of G1, wherein the operations comprise: causing a third request to be presented via the user interface, the third request requesting that the user present a sequence of objects in a field of view of a camera; comparing a depiction of the sequence of objects, which is captured by the camera, to a reference depiction of the sequence of objects; and providing the access to the resource to the user further based at least in part on the depiction of the sequence of objects, which is captured by the camera, corresponding to the reference depiction of the sequence of objects.

(G3) In the example computer program product of any of G1-G2, wherein the operations comprise: receiving a security indicator, which indicates that an amount of security to be applied to the computing system is less than a threshold amount; and causing the second request to be presented via the user interface based at least in part on the security indicator indicating that the amount of security to be applied to the computing system is less than the threshold amount.

(G4) In the example computer program product of any of G1-G3, wherein the operations further comprise: selecting a number of poses in the sequence of poses based at least in part on an age of the user, wherein a relatively lower age corresponds to a relatively lower number of poses in the sequence of poses, and wherein a relatively higher age corresponds to a relatively higher number of poses in the sequence of poses.

(G5) In the example computer program product of any of G1-G4, wherein the operations comprise: receiving the first request from the computing system that is associated with the user; and based at least in part on the first request being received from the computing system that is associated with the user, providing the access to the resource to the user without requiring multi-factor authentication of the user.

(G6) In the example computer program product of any of G1-G5, wherein the operations further comprise: determining that the user is associated with the computing system based at least in part on the computing system being used to log-in the user to a service.

(G7) In the example computer program product of any of G1-G6, wherein the operations comprise: obtaining a real-time biometric measurement of the user as a result of the first request being received; comparing the real-time biometric measurement to a reference biometric measurement associated with the user; and providing the access to the resource to the user further based at least in part on the real-time biometric measurement of the user corresponding to the reference biometric measurement.

(H1) A second example computer program product (FIG. 6, 624; FIG. 7, 718, 722) comprising a computer-readable storage medium having instructions recorded thereon for enabling a processor-based system (FIG. 1, 102A-102M, 106A-106N; FIG. 5, 500; FIG. 6, 602; FIG. 7, 700) to perform sequence-based authentication using rhythm by performing operations. The operations comprise causing (FIG. 3, 302) a first sequence request (FIG. 5, 536), which requests that a user generate a rhythmic sequence of sounds, to be presented via a user interface of a computing system. The operations further comprise receiving (FIG. 3, 304) a response (FIG. 5, 538) to the first sequence request via a microphone. The response to the first sequence request includes a first user-generated rhythmic sequence of sounds. The operations further comprise receiving (FIG. 3, 306) a resource request (FIG. 5, 526) for the user to be granted access to a resource. The operations further comprise, based at least in part on receipt of the resource request, causing (FIG. 3, 308) a second sequence request (FIG. 5, 546), which requests that the user repeat the first user-generated rhythmic sequence of sounds, to be presented via the user interface. The operations further comprise receiving (FIG. 3, 310) a response (FIG. 5, 548) to the second sequence request via the microphone. The response to the second sequence request includes a second user-generated rhythmic sequence of sounds. The operations further comprise comparing (FIG. 3, 312) the second user-generated rhythmic sequence of sounds to the first user-generated rhythmic sequence of sounds. The operations further comprise providing (FIG. 3, 314) access to the resource to the user based at least in part on a similarity between the second user-generated rhythmic sequence of sounds and the first user-generated rhythmic sequence of sounds satisfying a similarity criterion.

(H2) In the example computer program product of H1, wherein the operations comprise: providing the access to the resource to the user further based at least in part on a frequency distribution of the response to the second sequence request corresponding to a frequency distribution of the response to the first sequence request.

(H3) In the example computer program product of any of H1-H2, wherein the first user-generated rhythmic sequence of sounds includes a first spoken recitation of a name of the user; and wherein the second user-generated rhythmic sequence of sounds includes a second spoken recitation of the name of the user.

(H4) In the example computer program product of any of H1-H3, wherein the first user-generated rhythmic sequence of sounds includes a first sung recitation of lyrics of a song; and wherein the second user-generated rhythmic sequence of sounds includes a second sung recitation of the lyrics of the song.

(H5) In the example computer program product of any of H1-H4, wherein the operations comprise: providing the access to the resource to the user further based at least in part on a difference between the second user-generated rhythmic sequence of sounds and the first user-generated rhythmic sequence of sounds satisfying a difference criterion, the difference satisfying the difference criterion indicating that the second user-generated rhythmic sequence of sounds is not a recording of the first user-generated rhythmic sequence of sounds.

(H6) In the example computer program product of any of H1-H5, wherein the operations comprise: receiving the response to the first sequence request further via a camera, the response to the first sequence request further including a first rhythmic sequence of visual gestures in synchrony with the first user-generated rhythmic sequence of sounds; receiving the response to the second sequence request further via the camera, the response to the second sequence request further including a second rhythmic sequence of visual gestures in synchrony with the second user-generated rhythmic sequence of sounds; comparing the first rhythmic sequence of visual gestures and the second rhythmic sequence of visual gestures; and providing the access to the resource to the user further based at least in part on the second rhythmic sequence of visual gestures corresponding to the first rhythmic sequence of visual gestures.

(H7) In the example computer program product of any of H1-H6, wherein the operations comprise: receiving a security indicator, which indicates that an amount of security to be applied to the computing system is less than a threshold amount; and causing the second sequence request to be presented via the user interface based at least in part on the security indicator indicating that the amount of security to be applied to the computing system is less than the threshold amount.

(H8) In the example computer program product of any of H1-H7, wherein the operations further comprise: selecting a complexity of the rhythmic sequence based at least in part on an age of the user, wherein a relatively lower age corresponds to a relatively lower complexity of the rhythmic sequence, and wherein a relatively higher age corresponds to a relatively higher complexity of the rhythmic sequence.

(H9) In the example computer program product of any of H1-H8, wherein the operations comprise: receiving the resource request from the computing system, which is associated with the user; and based at least in part on the resource request being received from the computing system, which is associated with the user, providing the access to the resource to the user without requiring multi-factor authentication of the user.

(I1) A third example computer program product (FIG. 6, 624; FIG. 7, 718, 722) comprising a computer-readable storage medium having instructions recorded thereon for enabling a processor-based system (FIG. 1, 102A-102M, 106A-106N;

FIG. 5, 500; FIG. 6, 602; FIG. 7, 700) to perform sequence-based authentication using rhythm by performing operations. The operations comprise causing (FIG. 4, 402) a first sequence request (FIG. 5, 536), which requests that a user provide a rhythmic sequence of visual gestures, to be presented via a user interface of a computing system. The operations further comprise receiving (FIG. 4, 404) a response (FIG. 5, 538) to the first sequence request via a camera. The response to the first sequence request includes a first rhythmic sequence of visual gestures. The operations further comprise receiving (FIG. 4, 406) a resource request (FIG. 5, 526) for the user to be granted access to a resource. The operations further comprise, based at least in part on receipt of the resource request, causing (FIG. 4, 408) a second sequence request (FIG. 5, 546), which requests that the user repeat the first rhythmic sequence of visual gestures, to be presented via the user interface. The operations further comprise receiving (FIG. 4, 410) a response (FIG. 5, 548) to the second sequence request via the camera. The response to the second sequence request includes a second rhythmic sequence of visual gestures. The operations further comprise comparing (FIG. 4, 412) the second rhythmic sequence of visual gestures to the first rhythmic sequence of visual gestures. The operations further comprise providing (FIG. 4, 414) access to the resource to the user based at least in part on a similarity between the second rhythmic sequence of visual gestures and the first rhythmic sequence of visual gestures satisfying a similarity criterion.

(I2) In the example computer program product of I1, wherein the operations comprise: providing the access to the resource to the user further based at least in part on a tempo of the second rhythmic sequence of visual gestures corresponding to a tempo of the first rhythmic sequence of visual gestures.

(I3) In the example computer program product of any of I1-I2, wherein the operations comprise: providing the access to the resource to the user based at least in part on a similarity between a first head gesture in the first rhythmic sequence of visual gestures and a second head gesture in the second rhythmic sequence of visual gestures satisfying a similarity criterion.

(I4) In the example computer program product of any of I1-I3, wherein the operations comprise: providing the access to the resource to the user based at least in part on a similarity between a first hand gesture in the first rhythmic sequence of visual gestures and a second hand gesture in the second rhythmic sequence of visual gestures satisfying a second similarity criterion.

(I5) In the example computer program product of any of I1-I4, wherein the operations comprise: receiving a security indicator, which indicates that an amount of security to be applied to the computing system is less than a threshold amount; and causing the second sequence request to be presented via the user interface based at least in part on the security indicator indicating that the amount of security to be applied to the computing system is less than the threshold amount.

(I6) In the example computer program product of any of I1-I5, wherein the operations further comprise: selecting a complexity of the rhythmic sequence of visual gestures based at least in part on an age of the user, wherein a relatively lower age corresponds to a relatively lower complexity of the rhythmic sequence of visual gestures, and wherein a relatively higher age corresponds to a relatively higher complexity of the rhythmic sequence of visual gestures.

(I7) In the example computer program product of any of I1-I6, wherein the operations comprise: receiving the resource request from the computing system, which is associated with the user; and based at least in part on the resource request being received from the computing system, which is associated with the user, providing the access to the resource to the user without requiring multi-factor authentication of the user.

### IV. Example Computer System

FIG. 7 depicts an example computer 700 in which embodiments may be implemented. Any one or more of the user devices 102A-102M and/or any one or more of the servers 106A-106N shown in FIG. 1 and/or computing system 500 shown in FIG. 5 may be implemented using computer 700, including one or more features of computer 700 and/or alternative features. Computer 700 may be a general-purpose computing device in the form of a conventional personal computer, a mobile computer, or a workstation, for example, or computer 700 may be a special purpose computing device. The description of computer 700 provided herein is provided for purposes of illustration, and is not intended to be limiting. Embodiments may be implemented in further types of computer systems, as would be known to persons skilled in the relevant art(s).

As shown in FIG. 7, computer 700 includes a processing unit 702, a system memory 704, and a bus 706 that couples various system components including system memory 704 to processing unit 702. Bus 706 represents one or more of any of several types of bus structures, including a memory bus or memory controller, a peripheral bus, an accelerated graphics port, and a processor or local bus using any of a variety of bus architectures. System memory 704 includes read only memory (ROM) 708 and random access memory (RAM) 710. A basic input/output system 712 (BIOS) is stored in ROM 708.

Computer 700 also has one or more of the following drives: a hard disk drive 714 for reading from and writing to a hard disk, a magnetic disk drive 716 for reading from or writing to a removable magnetic disk 718, and an optical disk drive 720 for reading from or writing to a removable optical disk 722 such as a CD ROM, DVD ROM, or other optical media. Hard disk drive 714, magnetic disk drive 716, and optical disk drive 720 are connected to bus 706 by a hard disk drive interface 724, a magnetic disk drive interface 726, and an optical drive interface 728, respectively. The drives and their associated computer-readable storage media provide nonvolatile storage of computer-readable instructions, data structures, program modules and other data for the computer. Although a hard disk, a removable magnetic disk and a removable optical disk are described, other types of computer-readable storage media can be used to store data, such as flash memory cards, digital video disks, random access memories (RAMs), read only memories (ROM), and the like.

A number of program modules may be stored on the hard disk, magnetic disk, optical disk, ROM, or RAM. These programs include an operating system 730, one or more application programs 732, other program modules 734, and program data 736. Application programs 732 or program modules 734 may include, for example, computer program logic for implementing any one or more of (e.g., at least a portion of) the sequence-based authentication logic 108, the sequence-based authentication logic 508, the secret logic 512, the request receipt logic 514, the sequence logic 516, the comparison logic 518, the access logic 520, flowchart 200 (including any step of flowchart 200), flowchart 300 (including any step of flowchart 300), and/or flowchart 400 (including any step of flowchart 400), as described herein.

A user may enter commands and information into the computer 700 through input devices such as keyboard 738 and pointing device 740. Other input devices (not shown) may include a microphone, joystick, game pad, satellite dish, scanner, touch screen, camera, accelerometer, gyroscope, or the like. These and other input devices are often connected to the processing unit 702 through a serial port interface 742 that is coupled to bus 706, but may be connected by other interfaces, such as a parallel port, game port, or a universal serial bus (USB).

A display device 744 (e.g., a monitor) is also connected to bus 706 via an interface, such as a video adapter 746. In addition to display device 744, computer 700 may include other peripheral output devices (not shown) such as speakers and printers.

Computer 700 is connected to a network 748 (e.g., the Internet) through a network interface or adapter 750, a modem 752, or other means for establishing communications over the network. Modem 752, which may be internal or external, is connected to bus 706 via serial port interface 742.

As used herein, the terms “computer program medium” and “computer-readable storage medium” are used to generally refer to media (e.g., non-transitory media) such as the hard disk associated with hard disk drive 714, removable magnetic disk 718, removable optical disk 722, as well as other media such as flash memory cards, digital video disks, random access memories (RAMs), read only memories (ROM), and the like. A computer-readable storage medium is not a signal, such as a carrier signal or a propagating signal. For instance, a computer-readable storage medium may not include a signal. Accordingly, a computer-readable storage medium does not constitute a signal per se. Such computer-readable storage media are distinguished from and non-overlapping with communication media (do not include communication media). Communication media embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared and other wireless media, as well as wired media. Example embodiments are also directed to such communication media.

As noted above, computer programs and modules (including application programs 732 and other program modules 734) may be stored on the hard disk, magnetic disk, optical disk, ROM, or RAM. Such computer programs may also be received via network interface 750 or serial port interface 742. Such computer programs, when executed or loaded by an application, enable computer 700 to implement features of embodiments discussed herein. Accordingly, such computer programs represent controllers of the computer 700.

Example embodiments are also directed to computer program products comprising software (e.g., computer-readable instructions) stored on any computer-useable medium. Such software, when executed in one or more data processing devices, causes data processing device(s) to operate as described herein. Embodiments may employ any computer-useable or computer-readable medium, known now or in the future. Examples of computer-readable mediums include, but are not limited to storage devices such as RAM, hard drives, floppy disks, CD ROMs, DVD ROMs, zip disks, tapes, magnetic storage devices, optical storage devices, MEMS-based storage devices, nanotechnology-based storage devices, and the like.

It will be recognized that the disclosed technologies are not limited to any particular computer or type of hardware. Certain details of suitable computers and hardware are well known and need not be set forth in detail in this disclosure.

### V Conclusion

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims, and other equivalent features and acts are intended to be within the scope of the claims.

What is claimed is:

1. A system to perform sequence-based authentication using poses, the system comprising:
a memory; and
a processing system coupled to the memory, the processing system configured to:
receive a user-defined secret of a user, the user-defined secret indicating a sequence of shapes;
receive a first request for the user to be granted access to a resource;
cause the sequence of shapes to be presented via a user interface of a computing system that is associated with the user;
cause a second request, which requests that the user perform a sequence of poses in which a body of the user resembles the sequence of respective shapes, to be presented via the user interface;
compare a performance of the sequence of poses to the sequence of respective shapes; and
provide access to the resource to the user based at least in part on the performance of the sequence of poses corresponding to the sequence of respective shapes.

2. The system of claim 1, wherein the processing system is configured to:
cause a third request to be presented via the user interface, the third request requesting that the user present a sequence of objects in a field of view of a camera;
compare a depiction of the sequence of objects, which is captured by the camera, to a reference depiction of the sequence of objects; and
provide the access to the resource to the user further based at least in part on the depiction of the sequence of objects, which is captured by the camera, corresponding to the reference depiction of the sequence of objects.

3. The system of claim 1, wherein the processing system is configured to:
receive a security indicator, which indicates that an amount of security to be applied to the computing system is less than a threshold amount; and
cause the second request to be presented via the user interface based at least in part on the security indicator indicating that the amount of security to be applied to the computing system is less than the threshold amount.

4. The system of claim 1, wherein the processing system is further configured to:
select a number of poses in the sequence of poses based at least in part on an age of the user,
wherein a relatively lower age corresponds to a relatively lower number of poses in the sequence of poses, and
wherein a relatively higher age corresponds to a relatively higher number of poses in the sequence of poses.

5. The system of claim 1, wherein the processing system is configured to:
based at least in part on the first request being received from the computing system that is associated with the user, providing the access to the resource to the user without requiring multi-factor authentication of the user.

6. The system of claim 5, wherein the processing system is further configured to:
determine that the user is associated with the computing system based at least in part on the computing system being used to log-in the user to a service.

7. The system of claim 1, wherein the processing system is configured to:
obtain a real-time biometric measurement of the user as a result of the first request being received;
compare the real-time biometric measurement to a reference biometric measurement associated with the user; and
providing the access to the resource to the user further based at least in part on the real-time biometric measurement of the user corresponding to the reference biometric measurement.

8. A method of performing sequence-based authentication using rhythm, the method implemented by an authentication computing system, the method comprising:
causing a first sequence request, which requests that a user generate a rhythmic sequence of sounds, to be presented via a user interface of a computing system;
receiving a response to the first sequence request via a microphone, the response to the first sequence request including a first user-generated rhythmic sequence of sounds;
receiving a resource request for the user to be granted access to a resource;
based at least in part on receipt of the resource request, causing a second sequence request, which requests that the user repeat the first user-generated rhythmic sequence of sounds, to be presented via the user interface;
receiving a response to the second sequence request via the microphone, the response to the second sequence request including a second user-generated rhythmic sequence of sounds;
comparing the second user-generated rhythmic sequence of sounds to the first user-generated rhythmic sequence of sounds; and
providing access to the resource to the user based at least in part on a similarity between the second user-generated rhythmic sequence of sounds and the first user-generated rhythmic sequence of sounds satisfying a similarity criterion.

9. The method of claim 8, wherein providing the access to the resource to the user comprises:
providing the access to the resource to the user further based at least in part on a frequency distribution of the response to the second sequence request corresponding to a frequency distribution of the response to the first sequence request.

10. The method of claim 8, wherein the first user-generated rhythmic sequence of sounds includes a first spoken recitation of a name of the user; and
wherein the second user-generated rhythmic sequence of sounds includes a second spoken recitation of the name of the user.

11. The method of claim 8, wherein the first user-generated rhythmic sequence of sounds includes a first sung recitation of lyrics of a song; and
wherein the second user-generated rhythmic sequence of sounds includes a second sung recitation of the lyrics of the song.

12. The method of claim 11, wherein providing the access to the resource to the user comprises:
providing the access to the resource to the user further based at least in part on a difference between the second user-generated rhythmic sequence of sounds and the first user-generated rhythmic sequence of sounds satisfying a difference criterion, the difference satisfying the difference criterion indicating that the second user-generated rhythmic sequence of sounds is not a recording of the first user-generated rhythmic sequence of sounds.

13. The method of claim 8, wherein receiving the response to the first sequence request comprises:
receiving the response to the first sequence request further via a camera, the response to the first sequence request further including a first rhythmic sequence of visual gestures in synchrony with the first user-generated rhythmic sequence of sounds;
wherein receiving the response to the second sequence request comprises:
receiving the response to the second sequence request further via the camera, the response to the second sequence request further including a second rhythmic sequence of visual gestures in synchrony with the second user-generated rhythmic sequence of sounds;
wherein the method further comprises:
comparing the first rhythmic sequence of visual gestures and the second rhythmic sequence of visual gestures; and
wherein providing the access to the resource to the user comprises:
providing the access to the resource to the user further based at least in part on the second rhythmic sequence of visual gestures corresponding to the first rhythmic sequence of visual gestures.

14. The method of claim 8, further comprising:
receiving a security indicator, which indicates that an amount of security to be applied to the computing system is less than a threshold amount;
wherein causing the second sequence request to be presented via the user interface is based at least in part on the security indicator indicating that the amount of security to be applied to the computing system is less than the threshold amount.

15. The method of claim 8, further comprising:
selecting a complexity of the rhythmic sequence based at least in part on an age of the user,
wherein a relatively lower age corresponds to a relatively lower complexity of the rhythmic sequence, and
wherein a relatively higher age corresponds to a relatively higher complexity of the rhythmic sequence.

16. The method of claim 8, wherein receiving the resource request comprises:
receiving the resource request from the computing system, which is associated with the user; and
wherein providing the access to the resource to the user comprises:
based at least in part on the resource request being received from the computing system, which is associated with the user, providing the access to the resource to the user without requiring multi-factor authentication of the user.

17. A system to perform sequence-based authentication using rhythm, the system comprising:
a memory; and
a processing system coupled to the memory, the processing system configured to:
cause a first sequence request, which requests that a user provide a rhythmic sequence of visual gestures, to be presented via a user interface of a computing system;
receive a response to the first sequence request via a camera, the response to the first sequence request including a first rhythmic sequence of visual gestures;
receive a resource request for the user to be granted access to a resource;
based at least in part on receipt of the resource request, cause a second sequence request, which requests that the user repeat the first rhythmic sequence of visual gestures, to be presented via the user interface;
receive a response to the second sequence request via the camera, the response to the second sequence request including a second rhythmic sequence of visual gestures;
compare the second rhythmic sequence of visual gestures to the first rhythmic sequence of visual gestures; and
provide access to the resource to the user based at least in part on a similarity between the second rhythmic sequence of visual gestures and the first rhythmic sequence of visual gestures satisfying a similarity criterion.

18. The system of claim 17, wherein the processing system is configured to:
provide the access to the resource to the user further based at least in part on a tempo of the second rhythmic sequence of visual gestures corresponding to a tempo of the first rhythmic sequence of visual gestures.

19. The system of claim 17, wherein the processing system is configured to:
provide the access to the resource to the user based at least in part on a similarity between a first head gesture in the first rhythmic sequence of visual gestures and a second head gesture in the second rhythmic sequence of visual gestures satisfying a second similarity criterion.

20. The system of claim 17, wherein the processing system is configured to:
provide the access to the resource to the user based at least in part on a similarity between a first hand gesture in the first rhythmic sequence of visual gestures and a second hand gesture in the second rhythmic sequence of visual gestures satisfying a second similarity criterion.

21. The system of claim 17, wherein the processing system is configured to:
receive a security indicator, which indicates that an amount of security to be applied to the computing system is less than a threshold amount; and
cause the second sequence request to be presented via the user interface further based at least in part on the security indicator indicating that the amount of security to be applied to the computing system is less than the threshold amount.

22. The system of claim 17, wherein the processing system is further configured to:
select a complexity of the rhythmic sequence of visual gestures based at least in part on an age of the user,
wherein a relatively lower age corresponds to a relatively lower complexity of the rhythmic sequence of visual gestures, and
wherein a relatively higher age corresponds to a relatively higher complexity of the rhythmic sequence of visual gestures.

23. The system of claim 17, wherein the processing system is configured to:
based at least in part on the resource request being received from the computing system, which is associated with the user, provide the access to the resource to the user without requiring multi-factor authentication of the user.
